(19) United States
(12) Patent Application Publication
(10) Pub. No.: US 2009/0116457 A1
(43) Pub. Date: May 7, 2009

(54) METHODS AND ELECTRONIC DEVICES FOR WIRELESS AD-HOC NETWORK COMMUNICATIONS USING RECEIVER DETERMINED CHANNELS AND TRANSMITTED REFERENCE SIGNALS

(76) Inventor: Jacobus Haartsen, Hardenburg (NL)

Correspondence Address: ERICSSON INC., 6300 LEGACY DRIVE, M/S EVR 1-C-11, PLANO, TX, 75024, US

(21) Appl. No.: 12/353,018

(22) Filed: Jan. 13, 2009

Related U.S. Application Data
(63) Continuation of application No. 10/664,726, filed on Sep. 17, 2003.
(60) Provisional application No. 60/412,244, filed on Sep. 20, 2002.
(60) Provisional application No. 60/419,151, filed on Oct. 17, 2002.
(60) Provisional application No. 60/419,152, filed on Oct. 17, 2002.

(51) Int. Cl. H04B 7/216

(52) U.S. Cl. 370/335

(57) ABSTRACT

Electronic devices for communicating in wireless ad-hoc networks and multiple access systems (such as mobile radio telephone communications systems) are disclosed. For example, a disclosed transmitter can transmit data to a first receiver in an ad-hoc wireless network (or multiple access system) over a first channel and can, further, transmit data to a second receiver in the ad-hoc wireless network (or multiple access system) over a second channel that is separate from the first channel, where the first and second channels are determined by the respective receivers which will receive the first and second transmitted data. Accordingly, communications between transmitters and different receivers in the ad-hoc wireless network (or multiple access system) can be carried on simultaneously. Related receivers as well as methods, computer program products, and systems for communicating are also disclosed.

### CROSS-REFERENCE TO RELATED APPLICATIONS

This application is a continuation application which claims the benefit of U.S. patent application Ser. No. 10/664,726 filed on Sep. 17, 2003, the disclosure of which is fully incorporated herein by reference.

### TECHNICAL FIELD OF THE INVENTION

The invention relates to the field of communications in general, and more particularly, to wireless communications.

### DESCRIPTION OF THE RELATED ART

Many existing communications systems may be considered to be highly structured. For example, in cellular phone systems, such as GSM, UMTS, or CDMA2000, radio base stations control the transmissions between mobile radios and a wired backbone. The infrastructure used to control such systems can reside in a Public Land Mobile Network (PLMN), which can include sub-systems such as base station controllers (BSC) and mobile switching centers (MSC). The communications with the mobile radios can be provided over control channels defined by the system. Connection setup, channel allocation, handover, and other types of support functions can be controlled by the BSCs and the MSCs. FIG. 1 shows an example of a conventional system, wherein the operations of several base stations in close proximity of each other, can be coordinated to reduce interference between mobile radios and to provide handover when the mobile radio moves from one coverage area to another. In particular, the system can be responsible for handling mobility issues that may arise while using the system, such as the radio interface, roaming, authentication, and so on. The system can be separated from a conventional wire-line backbone, such as a Public Switched Telephone Network (PSTN), but may interface to the backbone via a gateway (GMSC). As shown in FIG. 1, typically only the connection between the radio and the base station (i.e., the last segment of a call) is wireless.

FIG. 2 shows wireless extensions to a wire-line backbone, such as the PSTN discussed above. In these types of systems, the BSC and MSC sub-systems shown in FIG. 1 may be absent as the wire-line backbones may not support mobility. Some examples of wireless extensions to wire-line backbones include DECT (a wireless extension of PSTN/ISDN) and IEEE 802.11, which is a wireless extension of Ethernet.

Many of the above systems can provide multiple users with access to the system essentially simultaneously. Access can be provided to the multiple users by, for example, dividing the radio band into multiple channels. These types of systems are sometimes referred to as multiple access systems, which can be provided using various approaches illustrated in FIGS. 3-5.

FIG. 3 illustrates an analog type multiple access approach that is commonly referred to as Frequency Division Multiple Access (FDMA) wherein access for N users is provided by N different frequencies ωᵢ. According to FIG. 3, N separate channels are provided at the different frequencies indicated by evenly spaced carriers at the different frequencies A. The information signal (TX signal i) generated by the respective user modulates a respective carrier ωᵢ to provide a respective transmitted signal. The transmitted signal can be received by a receiver by demodulating the transmitted signal using the same carrier frequency ωᵢ and processed by a low pass filter (LP Filter) to provide a received signal (RX signal i). The bandwidth of the transmitted signal combined with the carrier spacing can determine interference between adjacent channels. The Advanced Mobile Phone System (AMPS), the Nordic Mobile Telephone (NMT) system, and the Extended Total Access System (ETACS), are examples of systems based on FDMA.

In FDMA, channels may be confined to an intended channel, for example to reduce interference, by spacing adjacent carriers adequately (referred to as orthogonality). The relative positions of the carriers should remain in a fixed relationship to one another (i.e. the channels should not drift toward or away from one another). One way to reduce drift is to use a stable crystal oscillator as a reference for the frequency synthesizer in the radio.

Digital communications systems, such as the Global System for Mobile communications (GSM) and DAMPS, can allow multiple users to access the medium on the basis of time. Such systems are commonly referred to as Time Division Multiple Access (TDMA) systems, an example of which is shown in FIG. 4. As shown in FIG. 4, each of the N users can be assigned one of the N time slots tᵢ. The transmitters transmit the respective signal (TX signal i) during the respective assigned time. Similarly, the receivers receive the signals (RX signal i) during the assigned time slot. In some TDMA systems, such as those illustrated in FIG. 4, the channel provided by the carrier is divided into eight time slots. The channel can be defined by the carrier frequency and a time slot. Different users can be supported by different channels (i.e., a combination of the particular frequency and the assigned time slot). It is also known to combine aspects of TDMA and FDMA, wherein multiple carrier frequencies are divided into multiple time slots. The channels can, therefore, be specified by one of the frequencies in combination with one of the time slots.

In TDMA, channel orthogonality can be provided by preventing consecutive time slots from overlapping one another, which can be provided using stable clocks in the transceivers. In addition to a particular transmitter and receiver pair being synchronized in the system, the different receivers can be also be synchronized to one another to prevent the time slot assigned to one radio from drifting into another time slot assigned to another radio. Usually, this can be accomplished by synchronizing all radios to a central controller, such as a base station.

It is also known to provide multiple access communications using a technique that is commonly referred to as Code Division Multiple Access (CDMA), such as systems using Direct Sequence CDMA (DS-CDMA) or Direct Sequence Spread Spectrum (DSSS). As shown in FIG. 5, in DS-CDMA, the transmitted information (TX signal i) is spread with a high-rate spreading code (or signature) Sᵢ that is associated with the particular transmitter i. In the receiver, a correlation can be applied to the signal using the same spreading code Sᵢ to despread the signal to its original format (RX signal i). Typically, the spreading codes assigned to the transmitters are orthogonal relative to one another. If the spreading code used by the receiver does not match the spreading code used by the transmitter, the received signal will not be despread correctly and, therefore, may not be decoded. DS-CDMA techniques are used, for example, in IS-95, UMTS and CDMA-1000. Conventional Spread Spectrum processing is discussed further, for example, in Spread spectrum communications handbook. pp. 7-117. by Marvin K. Simon et al., published 1994 by McGraw-Hill, In. ISBN 0-07-057629-7.

It is also known to provide multiple access communications using a technique that is commonly referred to as Frequency-Hopping CDMA (FH-CDMA), as shown in FIG. 6A. According to FIG. 6A, each of the N transmitters in the multiple access system separates the information to be transmitted into different segments and transmits each of the different segments at a carrier frequency that changes over time. A “hop pattern” defines which carrier frequency is used at which time for data transmission. In particular, as time elapses each transmitter hops (or changes) from one carrier to another according to a pseudo-random hop code, Cᵢ(Ω,t), that is essentially unique to the particular transmitter.

Only the receiver that applies the same hop code Cᵢ applied during transmission can remain in synchronization with the transmitter that transmitted the data and, therefore, is the only receiver that can decode the information. An exemplary table in FIG. 6B shows an example of a hop pattern wherein the N transmitters change from one frequency to another frequency as a function of the hop codes applied by the different transmitters (and receivers) as a function of time.

One type of problem that may be encountered in both DS-CDMA and FH-CDMA type systems is the acquisition or initial code synchronization. If the spreading code is not synchronized to the signal at the receiver, the correct despreading may not be provided. Synchronization may be particularly difficult to obtain in low Signal-to-Noise Ratio (SNR) conditions. As a result, synchronization can be a lengthy process. This may pose a problem for asynchronous services where the transmissions are “bursty” and a synchronization phase may be needed for each new transmission.

Moreover, the acquisition delay may become an obstacle when large immunity against interference is desired. The Processing Gain (PG) in direct-sequence spread spectrum systems can be defined as the ratio between the Signal to Noise Ratio (SNR) after and before de-spreading:

PG=SNR_{despread}/SNR_{spread}

The above equation means that the SNR before de-spreading can be inversely proportional to the processing gain. Large processing gains can result in low SNR_{spread}. The SNR_{de-spread} after de-spreading can typically be about 5-10 dB. For example, with an SNR_{de-spread} of about 8 dB and a desired processing gain of about 20 dB, the SNR_{spread} can about −12 dB. In other words, under these conditions the signal may be buried in noise. Since the acquisition takes place before the signal is de-spread, the synchronization operates under low SNR_{spread} conditions. Moreover, the lower the SNR_{spread}, the longer the time acquisition may require. Ultra-large processing gain systems, which can be attractive because of the large immunity against interference, may therefore be handicapped by long acquisition delays.

In CDMA, channel orthogonality can be provided by the cross-correlation properties of the different codes used by the radios. However, code orthogonality may be provided only for certain phase differences between different codes, which may be obtained by synchronizing different transceivers. Moreover, this may be the case for DS-CDMA and FH-CDMA.

Another type of wireless system, commonly referred to as an “ad-hoc” system, is generally shown in FIG. 7. In contrast to many of the systems discussed above, ad-hoc systems may have little or no structure. Compliant devices may establish connections with other units directly without the mediation of a base station or other central controller. Different connections may be independently established without any coordination.

FIG. 8 shows an example of ad-hoc systems known as “Bluetooth”, wherein a single channel is shared among several devices in an ad-hoc network. According to FIG. 8, each of the ad-hoc networks 805A-D can operate independent of one another. A master device in each ad-hoc network establishes a single channel that all of the devices in the ad-hoc network use for communications. For example, if device 810A is master of ad-hoc network 805A, devices 815A and 820A communicate over a channel that is determined by the master device 810A. Furthermore, only one of the devices can transmit in the ad-hoc network 805A at a single time. The master device 810A does not control the communications that occur in ad-hoc networks 805B-805D.

Frequency Hopping Code Division Multiple Access (FH-CDMA) techniques can be used by different ad-hoc networks, which may be near to one another. When FH-CDMA is used, each ad-hoc master may define a unique hopping sequence for the associated ad-hoc network to reduce interference with the other ad-hoc networks.

Bluetooth is described in further detail at www.bluelooth.com, and is described generally in a publication by Haartsen, entitled Bluetooth—The Universal Radio Interface for Ad-hoc. Wireless Connectivity, Ericsson Review No. 3, 1998, pp. 110-117, the disclosures of both of which are hereby incorporated herein by reference in their entirety as if set forth fully herein.

The unstructured nature of ad-hoc systems, such as Bluetooth, may give rise to some problems that may not be encountered in the other types of mobile systems mentioned above. For example, in ad-hoc systems there may be little control over interference. Because of lack of coordination and synchronization, channels cannot be made orthogonal which poses a problem to use the conventional multiple access methods as described above. Furthermore, the transmit power and the distance between the receiver and the interferer may not be controlled, which may cause the interference to have a received power that is greater than the received power of the intended signal. This is sometime referred to as “the near-far problem.” This means that even signals that are separated in frequency may interfere with each other because the leakage from one signal to another becomes large due to the high power of the transmitter or, alternatively, because of the relatively small distance between the transmitter and the receiver.

FIG. 9A shows a situation in which the near-far problem discussed above may be exhibited. In particular, a transmitter 905 in communication with a receiver 910 is interfered by a device 915. As shown in FIG. 9A, the device 915 is much closer to the receiver 910 and may also have a larger output power than the transmitter 905. Although the device 915 may be transmitting on a different frequency than the transmitter 905, the spectral leakage entering the channel filter of receiver 910 may be great enough to interfere with the reception of the signals from the transmitter 905. The signal of the device 915 may also drive the receiver 910 into saturation, which is sometimes referred to as de-sensitization or blocking.

Another difficulty that may arise in ad-hoc systems is the problem associated with so-called “hidden nodes” which is shown in FIG. 9B. The hidden node problem refers to the fact that transmitter 905 and device 920 may not be within range of one another, but may both be within range of another device 910. If transmitter 905 needs to transmit to device 910 and, therefore, first determines whether the channel is free, the transmitter 905 may not recognize that there is an ongoing transmission between devices 910 and 920 since device 920 is out of range of the transmitter 905. Accordingly, transmitter 905 believes that the channel is free and stars transmitting, which will disturb the ongoing transmission between devices 910 and 920. As discussed above, device 920 may not be detected by the radio 905 due to the device 920 being out of range.

Another difficulty that may arise in ad-hoc systems is identifying the devices to which the ad-hoc connections are to be made. A discovery process may be conducted to determine the devices that are in range and what connections can be established. In particular, the ad-hoc devices may constantly scan the radio interface to detect setup messages, which may increase power consumption of ad-hoc devices.

Moreover, many of these systems also may require a connection to be established before the transfer of data can occur. If the interval between data transmissions is short, maintaining the established connection may be acceptable. On the other hand, if the interval is relatively long, it may be beneficial to terminate the connection to reduce power consumption and interference. However, terminating the connection may incur the overhead associated with establishing a new connection before any further data transmissions can take place. Moreover, if large processing gains are desired, the long acquisition and synchronization delay prevents the system to release the connection after each data transfer. The problems encountered in ad-hoc systems as listed above can be combated with a spreading technique using extremely large processing gains (Ultra-large processing gain) as will be described in the application.

### SUMMARY

Embodiments according to the invention can provide methods, electronic devices, and systems for communicating in wireless ad-hoc networks and multiple access systems (such as mobile radio telephone communications systems). For example, in some embodiments according to the invention, a transmitter can transmit data to a first receiver in an ad-hoc wireless network (or multiple access system) over a first channel and can, further, transmit data to a second receiver in the ad-hoc wireless network (or multiple access system) over a second channel that is separate from the first channel. Accordingly, communications between transmitters and different receivers in the ad-hoc wireless network (or multiple access system) can be carried on simultaneously.

Furthermore, in some embodiments according to the present invention, the channel over which the transmitter communicates with the receiver is determined by the receiver. For example, the transmitter can request an identifier for the channel over which the receiver receives data. In response, the receiver can transmit its channel identifier to the transmitter, which can in turn use the receiver's channel identifier to transmit data to the receiver.

The different channels for the receivers in the ad-hoc wireless network (or multiple access system) can be provided by different functions or offsets. For example, in some embodiments according to the invention, a first receiver in the ad-hoc wireless network (or multiple access system) can specify a channel, over which data can be provided, as a first offset whereas the second receiver specifies a second channel; over which it receives data as a second offset. Therefore, a transmitter can communicate with the first receiver by transmitting using the first offset and can communicate with the second receiver by transmitting using the second offset. Moreover, transmissions to the second receiver are not detected by the first receiver as the first and second offsets provide different channels over which communications can be carried out.

In some embodiments according to the invention, the offset is a frequency offset Δω. For example, the first receiver in the ad-hoc wireless network (or multiple access system) can specify a first frequency offset Δω₁ to be used by transmitters wishing to transmit data to the first receiver. A second receiver in the ad-hoc wireless network (or multiple access system) can specify a second frequency offset Δω₂ over which data can be provided to the second receiver. Accordingly, a transmitter can transmit to the first receiver using the first frequency offset Δω₁ and can transmit to the second receiver using the second frequency offset Δω₂.

In still other embodiments according to the invention, the offset is a time offset Δτ. Accordingly, the first receiver can define the first channel as a first time offset Δτ₁ whereas the second receiver can specify the second channel as a second time offset Δτ₂. Therefore, the transmitter can transmit to the first receiver using the first time offset Δτ₁ and can transmit to the second receiver using the second time offset Δτ₂.

In still other embodiments according to the invention, a reference signal (or spreading code) used to spread a transmitted information signal, is transmitted to the receiver as a component of a transmitted composite signal. The receiver can despread the received signal by implicitly using the reference signal that is included in the composite signal. No prior knowledge of the reference signal is needed at the receiver. Embodiments according to the invention can, therefore, use a reference signal that is essentially (or truly) random and is very long as the spreading code. The random nature and the long length of the reference signal can provide very low cross-correlation. The large spreading provided by the reference signals can, therefore, provide what is commonly referred to as “Ultra-Large Processing Gain” for the received signal. Moreover, because the reference signal is transmitted with the data, the receiver may be able to despread the received signal quickly, since acquisition under low SNR conditions is not required.

In some embodiments according to the invention, the reference signal is modulated with the frequency offset associated with some of the embodiments discussed herein. In other embodiments according to the invention, the composite signal includes the reference component and the information component where one of the components is delayed with respect to the other by the time offset discussed herein.

### BRIEF DESCRIPTION OF THE DRAWINGS

FIG. 1 is a schematic diagram that illustrates conventional communication systems.

FIG. 2 is a schematic diagram that illustrates wireless extensions to conventional communications systems.

FIG. 3 is a schematic diagram that illustrates a conventional FDMA system.

FIG. 4 is a schematic diagram that illustrates a conventional TDMA system.

FIG. 5 is a schematic diagram that illustrates a conventional direct sequence CDMA system.

FIG. 6A is a schematic diagram that illustrates a conventional FH-CDMA system.

FIG. 6B is a table that illustrates frequency hopping as a function of time in a conventional FH-CDMA systems as shown in FIG. 6A.

FIG. 7 is a schematic diagram that illustrates a conventional ad-hoc network.

FIG. 8 is a schematic diagram that illustrates network topology of a conventional ad-hoc system known as Bluetooth.

FIGS. 9A and 9B are schematic diagrams that illustrate near-far problems and hidden node problems associated with conventional sd-hoc networks.

FIG. 10 is a block diagram that illustrates embodiments of electronic devices according to the invention.

FIG. 11 is a schematic diagram that illustrates operations of embodiments according to the invention.

FIG. 12 is a schematic diagram that illustrates embodiments of a data transmission structure according to the invention.

FIG. 13 is a flow chart that illustrates operations of embodiments according to the invention.

FIGS. 14-18 are schematic diagrams that illustrate embodiments of transmitters circuits and receiver circuits according to the invention.

FIG. 19 is a graph that illustrates respective bandwidths of the components of a composite signal according to the invention.

FIGS. 20-23 are schematic diagrams that illustrate embodiments of transmitter circuits and receiver circuits according to the invention.

FIGS. 24-30 are schematic diagrams that illustrate embodiments of transmitter circuits and receiver circuits according to the invention.

FIGS. 31-33 are schematic diagrams that illustrate embodiments of data transmission and reception according to the invention.

FIG. 34 is a schematic diagram that illustrates the shifting of a composite signal and the correlation of the composite signal with the shifted composite signal at a receiver according to embodiments of the invention.

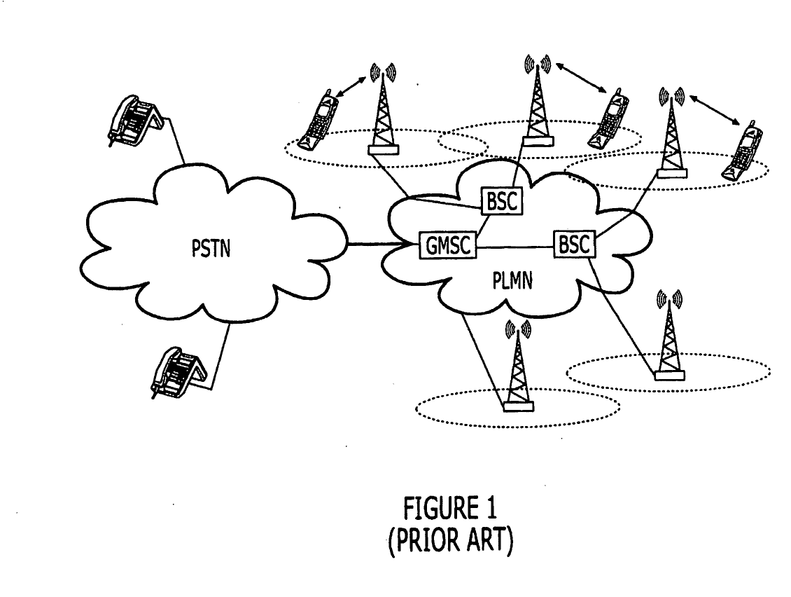

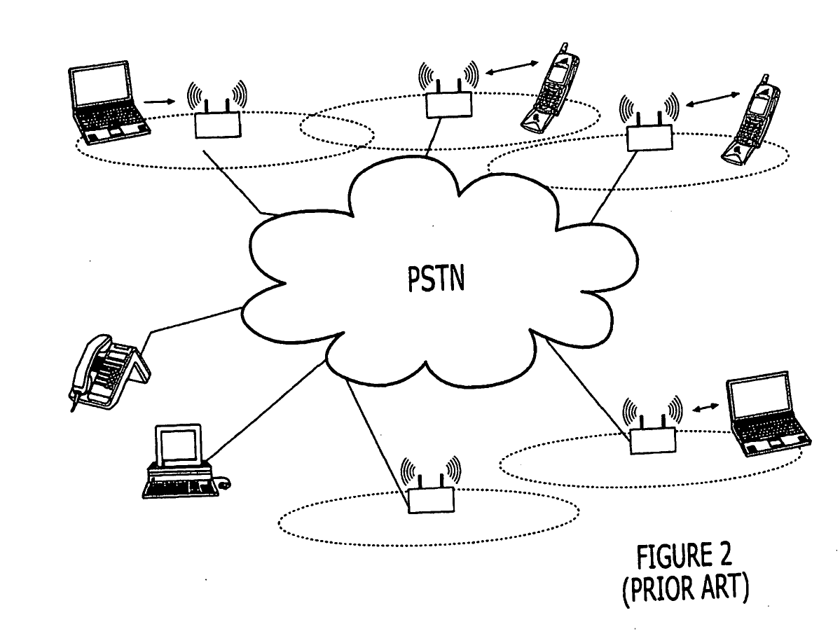

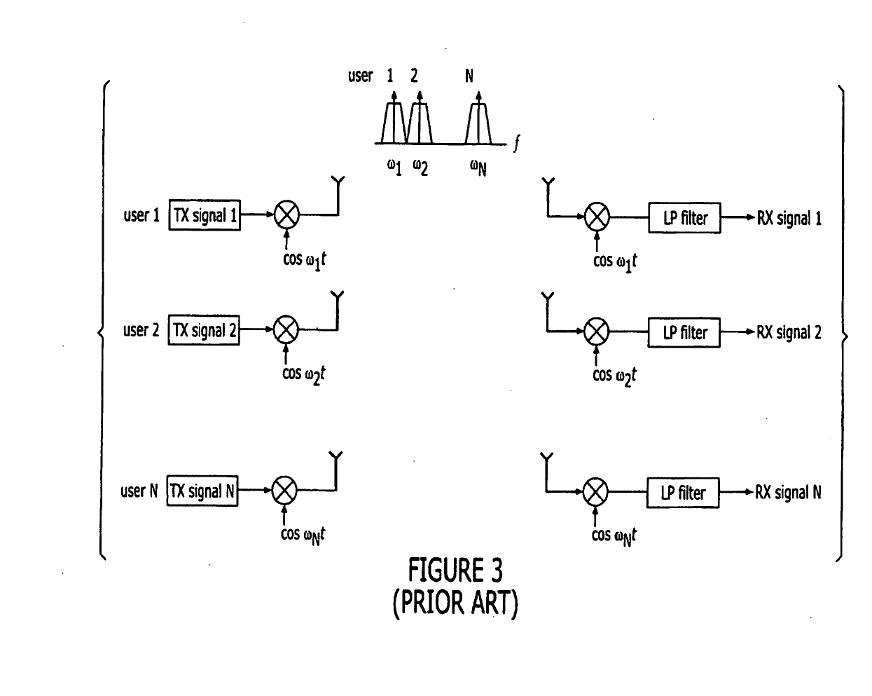

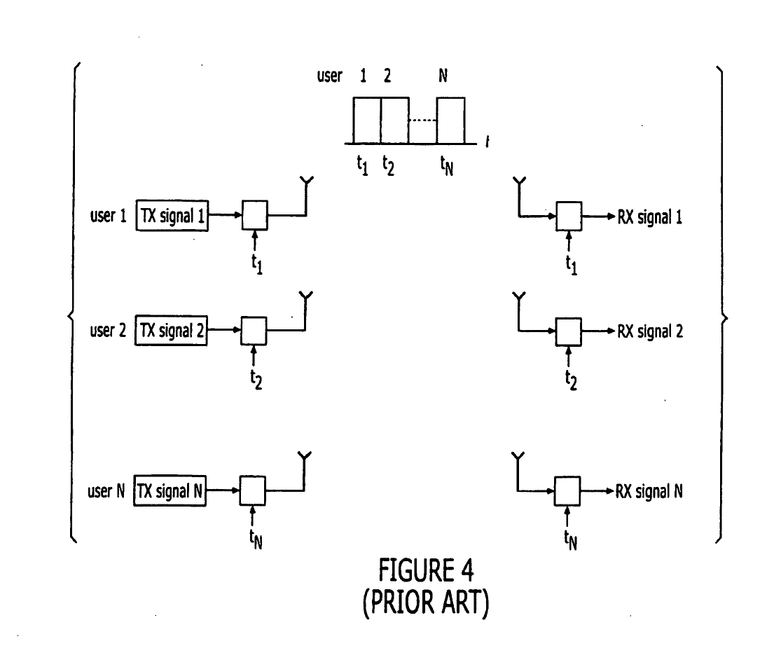

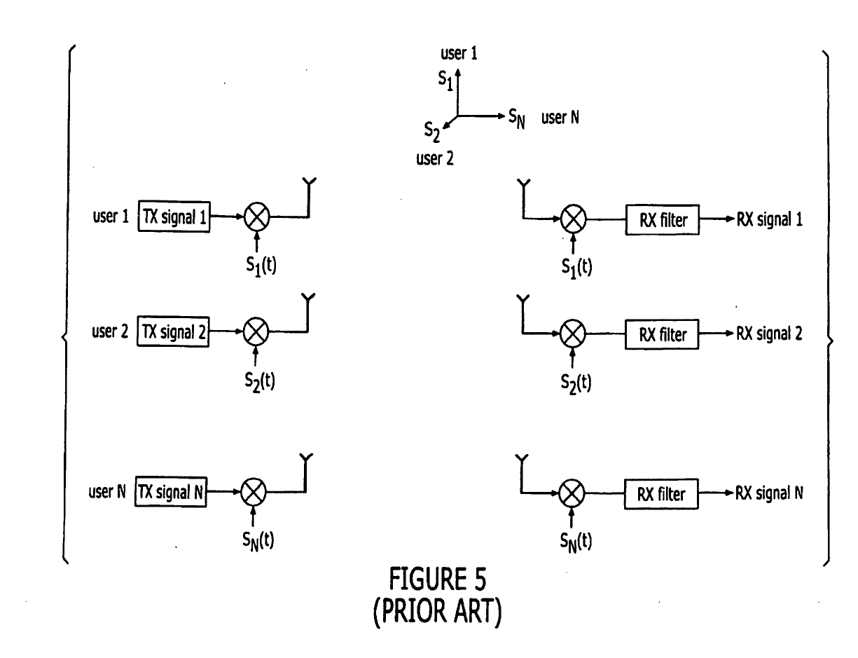

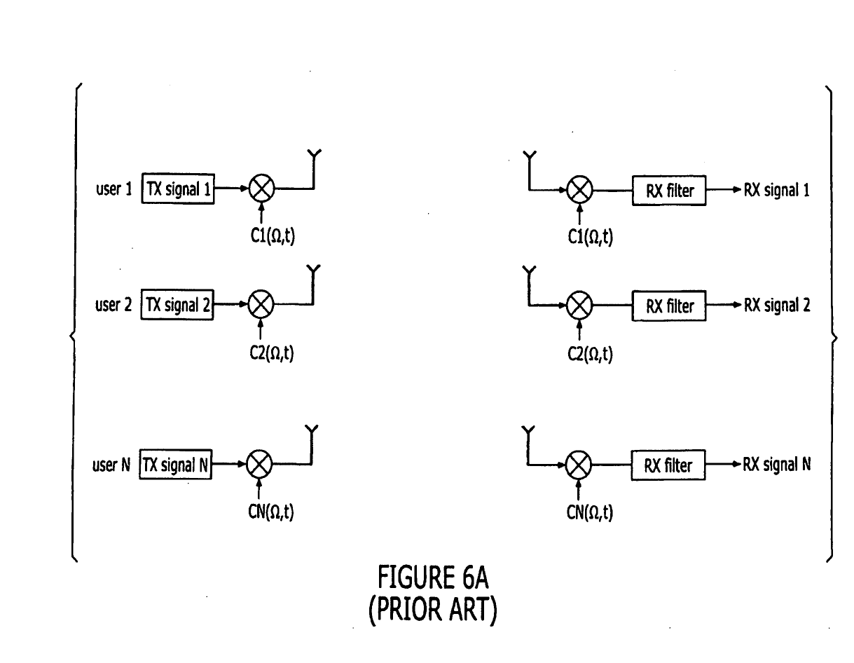

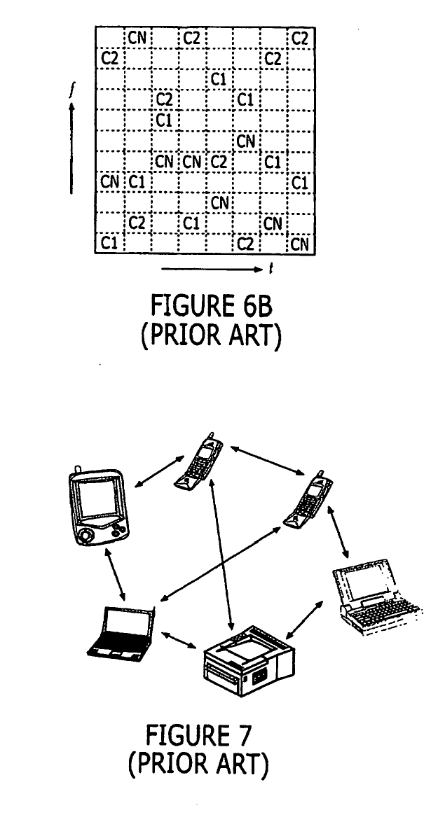

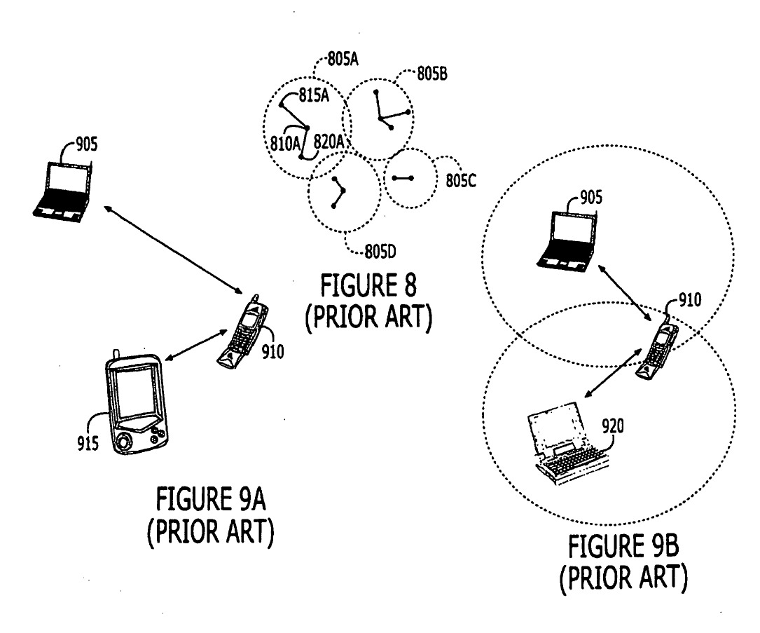

### DETAILED DESCRIPTION OF EMBODIMENTS

The invention is described more fully hereinafter with reference to the accompanying drawings, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

As will be appreciated by one of skill in the art, the present invention may be embodied as methods, electronic devices, such as a radiotelephone, systems, and/or computer program products. Accordingly, the present invention may take the form of hardware embodiments, software embodiments or embodiments that combine software and hardware aspects.

The present invention is disclosed using (block and flowchart) diagrams. It will be understood that each block (of the flowchart illustration and block diagrams), and combinations of blocks, can be implemented using computer program instructions. These program instructions may be provided to a processor circuit(s) within the mobile user terminal or system, such that the instructions which execute on the processor circuit(s) create means for implementing the functions specified in the block or blocks.

The computer program instructions may be executed by the processor circuit(s), such as a Digital Signal Processor, to cause a series of operational steps to be performed by the processor circuit(s) to produce a computer implemented process such that the instructions which execute on the processor circuit(s) provide steps for implementing the functions specified in the block or blocks. Accordingly, the blocks support combinations of means for performing the specified functions, combinations of steps for performing the specified functions and program instructions for performing the specified functions. It will also be understood that each block, and combinations of blocks, can be implemented by special purpose hardware-based systems which perform the specified functions or steps, or combinations of special purpose hardware and computer instructions.

Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code or “code” or instructions for carrying out operations according to the present invention may be written in an object oriented programming language such as JAVA®, or in various other programming languages. Software embodiments of the present invention do not depend on implementation with a particular programming language.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the diagram block or blocks.

The invention is generally described herein in the context of an electronic device, such as a radio telephone. In such electronic devices, an antenna can radiate electromagnetic waveforms generated by a transmitter located within the electronic device. The waveforms are propagated in a radio propagation medium, and are received by a receiver via one or more antennas. It will be understood that the receivers described herein can be included with the transmitters to provide a transceiver for the electronic device.

As used herein, the term “electronic device” may include, any electronic device that is configured to operate in a wireless ad-hoc network or a multiple access system, specifically including, among other devices, a single or dual mode cellular radiotelephone with or without a multi-line display; a Personal Communications System (PCS) terminal that may combine a cellular radiotelephone with data processing, facsimile and data communications capabilities; a headset; a tablet or pen based computer, a Personal Data Assistant (“PDA”) that can include a radiotelephone (e.g. what is sometimes referred to as a “smart phone”), pager, Internet/intranet access, Web browser, organizer, calendar and/or a global positioning system (GPS) receiver, a conventional laptop computer, a palmtop computer, and/or general purpose desktop computer, a tablet computer or other appliances which can include a transceiver. Other types of electronic devices can be included.

Embodiments according to the invention can provide methods, electronic devices, systems and computer program products for communicating in wireless ad-hoc networks and multiple access systems (such as mobile radio telephone communications systems). For example, in some embodiments according to the invention, a transmitter can transmit data to a first receiver in an ad-hoc wireless network (or multiple access system) over a first channel and can, farther, transmit data to a second receiver in the ad-hoc wireless network (or multiple access system) over a second channel that is separate from the first channel, where the first and second channels are determined by the respective receivers which will receive the first and second transmitted data. Accordingly, communications between transmitters and different receivers in the ad-hoc wireless network (or multiple access system) can be carried on simultaneously.

Furthermore, in some embodiments according to the present invention, the receiver can determine the channel over which the transmitter communicates with the receiver. For example, the transmitter can request an identifier for a receiver to which data is to be transmitted. In response, the receiver can transmit its identifier to the transmitter, which can in turn use the receiver's identifier to transmit the data over channel that is based on the receiver's identifier.

The different channels for the receivers in the ad-hoc wireless network (or multiple access system) can be provided by different functions or offsets. For example, in some embodiments according to the invention, a first receiver in the ad-hoc wireless network (or multiple access system) can specify an identifier that can be used to transmit data to the receiver over a first channel that is specified as a first offset whereas the second receiver specifies a second identifier, which can be used to transmit data thereto over a second channel that is specified as a second offset that is different than the first offset. Therefore, a transmitter can communicate with the first receiver by transmitting using the first offset and can communicate with the second receiver by transmitting using the second offset. Moreover, transmissions to the second receiver are not received by the first receiver as the first and second offsets provide different channels over which communications can be carried out.

In some embodiments according to the invention, the offset is a frequency offset Δω. For example, the first receiver in the ad-hoc wireless network (or multiple access system) can specify a first frequency offset Δω₁ to be used by transmitters wishing to transmit data to the first receiver. A second receiver in the ad-hoc wireless network (or multiple access system) can specify a second frequency offset ΔΩ₂ over which data can be provided to the second receiver. Accordingly, a transmitter can transmit to the first receiver using the first frequency offset Δω₁ and can transmit to the second receiver using the second frequency offset Δω₂.

In still other embodiments according to the invention, the offset is a time offset Δτ. Accordingly, the first receiver can define the first channel as a first time offset Δτ₁ whereas the second receiver can specify the second channel as a second time offset Δτ₂. Therefore, the transmitter can transmit to the first receiver using the first time offset Δτ₁ and can transmit to the second receiver using the second time offset Δτ₂.

In still other embodiments according to the invention, a reference signal (or spreading code) used to spread a transmitted information signal, is transmitted to the receiver as a component of a transmitted composite signal. The receiver can despread the received signal by implicitly using the reference signal that is included in the composite signal. No prior knowledge of the reference signal is needed at the receiver. Embodiments according to the invention can, therefore, use a reference signal that is essentially (or truly) random and is very long as the spreading code. The random nature and the long length of the reference signal can provide very low cross-correlation. The large spreading provided by the reference signals can, therefore, provide what is commonly referred to as “Ultra-Large Processing Gain” for the received signal. Moreover, because the reference signal is transmitted with the data, the receiver may be able to despread the received signal quickly.

In some embodiments according to the invention, the reference signal is modulated with the frequency offset associated with some of the embodiments discussed herein. In other embodiments according to the invention, the reference signal component that is part of a composite signal (including the reference signal component and a modulated information signal component) is delayed by the time offset discussed herein.

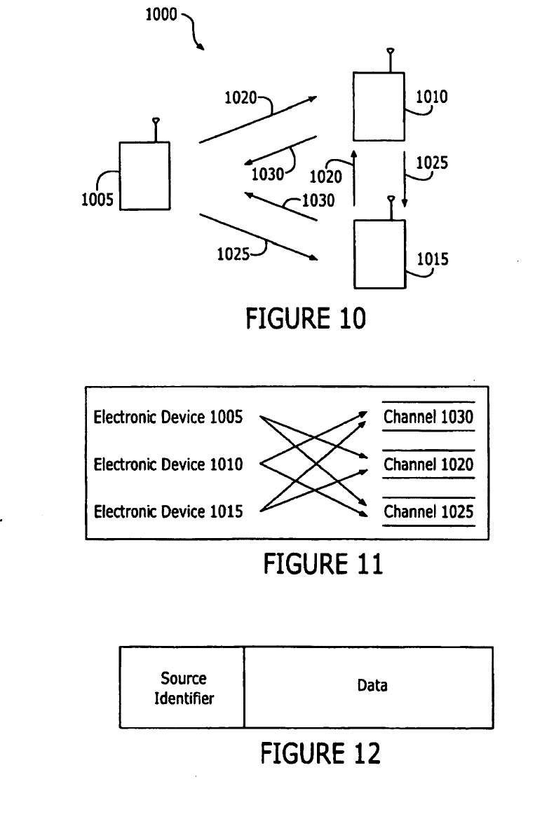

FIG. 10 is a schematic diagram that illustrates a plurality of electronic devices operating in an established ad-hoc network 1000 according to embodiments of the invention. It will be further understood that the electronic devices described herein include transmitter circuits (for transmitting data) and receiver circuits (for receiving data) in the ad-hoc network 1000.

According to FIG. 10, each electronic device in the ad-hoc network 1000 defines an associated unique channel over which data can be received from any other compliant electronic device. For example, the first electronic device 1005 has an associated unique channel 1030 over which it receives data in the ad-hoc network 1000. Any other electronic device in the ad-hoc network 1000 can transmit data to the first electronic device 1005 by transmitting data on the channel 1030. Furthermore, a second electronic device 1010 has an associated unique channel 1020 over which it can receive data in the ad-hoc network 1000. For example, the first electronic device 1005 can transmit data to the second electronic device 1010 by transmitting data over the unique channel 1020 associated with the second electronic device 1010. A third electronic device 1015 defines an associated unique channel 1025 over which it can receive data in the ad-hoc network 1000. For example, the second electronic device 1010 can transmit data to the third electronic device 1015 over the unique channel 1025.

Because the transmitters can transmit to receivers in the ad-hoc network 1000 without checking whether other devices are transmitting, collisions may occur when, for example, multiple transmitters transmit to a single receiver. Accordingly, embodiments according to the invention may utilize an acknowledgement scheme where, for example, the receiver transmits an acknowledgement signal to the transmitter upon successful reception of data from the transmitter. If the transmitter does not receive an acknowledgement from the intended receiver, the transmitter may attempt to re-transmit the same data to the receiver after expiration of a time interval, which can be selected to allow a conflicting transmission that the receiver is conducting to complete.

Therefore, communications may be carried out between any of the electronic devices using a pair of the unique channels associated with each of the devices. In other words, duplex data transmission can be provided using a pair of unidirectional channels wherein each channel in the pair is unique to one of the electronic devices. For example, communications between the first electronic device 1005 and the second electronic device 1010 can occur over the pair of channels 1020 and 1030 to provide duplex communications. Furthermore, communications between the electronic devices can occur at any time without any coordination with any other communications in the ad-hoc network or without any other prior connections between the devices. For example, the first electronic device 1005 can transmit to any other electronic device without first checking whether other devices are communicating. The mutual interference problem is addressed by suppressing or reducing the effects of unwanted signals in the ultra-large processing gain receivers discussed herein.

FIG. 11 is a schematic diagram that further illustrates data communications in the ad-hoc network 1000 according to the embodiments of the invention. In particular, in embodiments according to the invention, data can be transmitted to a receiver in any of the electronic devices in the ad-hoc network 1000 by transmitting data over the channel that is unique to the target electronic device. For example, according to FIG. 11, the first electronic device 1005 can transmit data to a receiver in the second electronic device 1010 by transmitting data over the unique channel 1020 that is determined by the second electronic device 1010. Furthermore, the first electronic device 1005 can transmit data to a receiver in the third electronic device 1015 by transmitting the data over the unique channel 1025 that is determined by the third electronic device 1015. The second electronic device 1010 can transmit data to either the first electronic device 1005 or to the third electronic device 1015 by transmitting data over either the unique channel 1030 or over the unique channel 1025 respectively. Similarly, the third electronic device 1015 can transmit data to the first and second electronic devices 1005, 1010 by transmitting data over unique channels 1030 and 1020 respectively.

The electronic devices operating in the ad-hoc network 1000 can also perform a discovery phase where any of the electronic devices can determine the unique channels associated with the other electronic devices in the ad-hoc network 1000. In particular, each of the electronic devices included in the ad-hoc network 1000 can receive signals over a common channel (which is not shown in FIG. 10 or 11). The common channel allows any of the electronic devices in the ad-hoc network 1000 (or an electronic device which has yet to join the ad-hoc network 1000) to broadcast a request which prompts any of the electronic devices that receive the request to respond by transmitting a channel identifier that is associated with the unique channel over which the responding electronic device receives in the ad-hoc network 1000. Each of the responses to the broadcast request can be transmitted by the respective electronic device on the common channel so that the electronic device that broadcasted the request can receive the responses.

FIG. 12 is a schematic illustration of an exemplary structure of a data transmission by an electronic device according to embodiments of the invention. In particular, a first portion of the data transmission includes an identifier that identifies the source of the data transmission in the ad-hoc network. For example, referring to FIG. 12, if the first electronic device 1005 (i.e., the source) transmits data to the second electronic device 1010, the first portion of the data transmission would include the identifier associated with the first electronic device 1005 and hence identifying channel 1030.

A remaining portion of the data transmission includes data that is associated with some function to be carried out in the ad-hoc network 1000, such as voice and/or data associated with radio transmissions. For example, the remaining portion can include data that was requested by the electronic device 1010. Accordingly, the second electronic device 1010 can provide a response to the transmission from the electronic device 1005 by using the source's identifier that was included with the data (i.e., identifier 1030). Therefore, the second electronic device 1010 responds by transmitting data over channel 1030 whereby the first electronic device 1005 will receive the response.

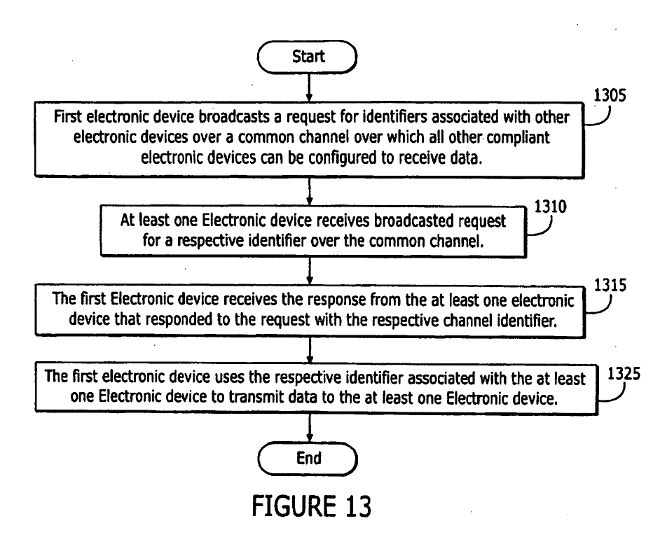

FIG. 13 illustrates operations of embodiments according to the invention, wherein an electronic device broadcasts a request for channel identifiers associated with receivers. Referring to FIG. 13, an electronic device broadcasts a request for channel identifiers associated with other electronic devices that can receive the request (block 1305). As discussed above, the request can be broadcast on a common channel over which all other compliant electronic devices can be configured to receive data in an ad-hoc network according to the invention. It will be understood that embodiments of electronic devices according to the invention may broadcast requests for channel identifiers periodically or may broadcast requests based upon an external factor. Any receiver that is within range of the electronic device that broadcast the request, receives the broadcasted request for respective channel identifiers over the common channel (block 1310). The electronic device that broadcast the request can receive the responses from the electronic devices including the respective channel identifiers over the common channel (block 1315). Alternatively, the devices responding to the request can do so using a source identifier that was included with the request. The electronic device that broadcast the request can utilize the received identifiers to transmit data to each of the respective electronic devices as needed (block 1325).

As discussed above, transmitters and receivers in ad-hoc networks (or multiple access systems) according to the invention can receive data over unique channels within the ad-hoc network (or multiple access system). In further embodiments according to the invention, unique channels can also be provided using offsets in, for example, multiple access systems. In particular, unique offsets in frequency and/or time can be used to provide unique channels for transmitters and receivers circuits to communicate.

Furthermore, the unique channels in the multiple access systems (and ad-hoc networks) according to the invention can be used to transmit reference signals (such as spreading codes) that are also used to modulate an information signal (such as voice or data provided by a user) together with the modulated information signal. Transmitting the reference signal and the modulated information signal as components of the transmitted signal may allow the receiver to decode (e.g., despread and demodulate) the information signal by applying the same offset as the one used by the transmitter. The reference signal can be used implicitly by the receiver to despread the composite signal that includes the reference signal. For example, a spreading code can be shifted by a frequency offset and combined with the information signal to provide a composite signal which is transmitted to the receiver. The receiver can despread and demodulate the information signal by shifting the composite signal (with the frequency offset) and demodulating the received composite signal with the shifted version of the composite signal.

In some embodiments according to the invention, different portions of the information signal transmitted to a receiver can be spread using different types of reference signals. For example, a first portion of the information signal (or data), such as a preamble of a data packet, can include a modulated information signal (i.e., an information signal modulated with a spreading code) and the spreading code component itself (i.e., a transmitted reference signal) as discussed in detail herein. A second portion of the information signal, such as the payload of the data transmission, is spread using a locally generated spreading code (i.e., generated at the transmitter) and is despread at the receiver using a locally generated (i.e. generated at the receiver) reference which corresponds to the spreading code locally generated at the transmitter. Accordingly, the locally generated reference can provide better performance than the transmitted reference (e.g., such as providing a lower Bit Error Rate than what is provided using the transmitted reference). Moreover, the first portion of the information signal can include seed information to indicate a starting point for the generation of the second spreading code to the second portion of the data transmission.

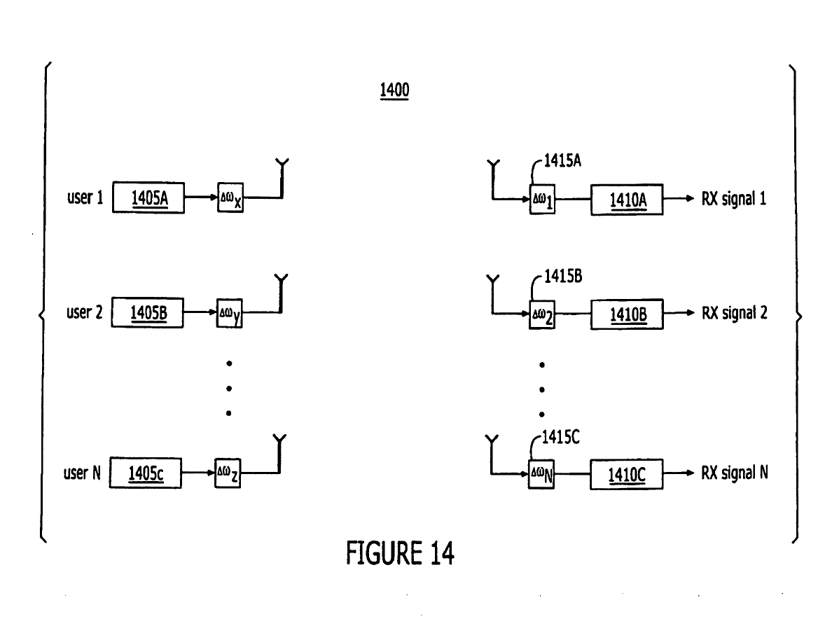

FIG. 14 is a schematic diagram that illustrates embodiments of transmitter and receiver circuits according to the invention. In particular, each of the transmitters 1405A-1405C uses a respective unique frequency offset Δω to transmit to different receivers 1410A-C in a multiple access system 1400. For example, a receiver 1410A determines a first frequency offset Δω₁ over which any of the transmitters 1405A-C can transmit data thereto. The first transmitter 1405A uses the unique frequency offset Δω₁ to transmit data to the first receiver 1410A. Similarly, the second receiver 1410B determines a second unique frequency offset Δω₂, which transmitters 1405A-C can use to transmit data thereto, whereas the third receiver 1410C determines another unique frequency offset Δω_{N} which transmitters 1405A-C can use to transmit data thereto.

By using a unique frequency offset Δω each receiver only demodulates data that is transmitted using the corresponding frequency offset. For example, the receiver 1410A uses the frequency offset Δω₁ to receive, accordingly, the first transmitter 1405A needs to use an, as the value of the frequency offset Δωₖ to transmit to the first receiver 1410A. Similarly, the second transmitter 1405B uses Δω₁ as the value of the frequency offset Δω_{y} to transmit to the first receiver 1410A. Finally, the third transmitter 1405C uses Δω₁ as the value of the frequency offset Δω₂ to transmit to the first receiver 1410A. Furthermore, the transmitters 1405A-C use the frequency offsets determined by the second and third receivers 1410B-C to transmit to those receivers in a similar fashion. Accordingly, the different frequency offsets determined by the receivers allow the transmitters to communicate with any of the receivers in the multiple access system 1400 simultaneously.

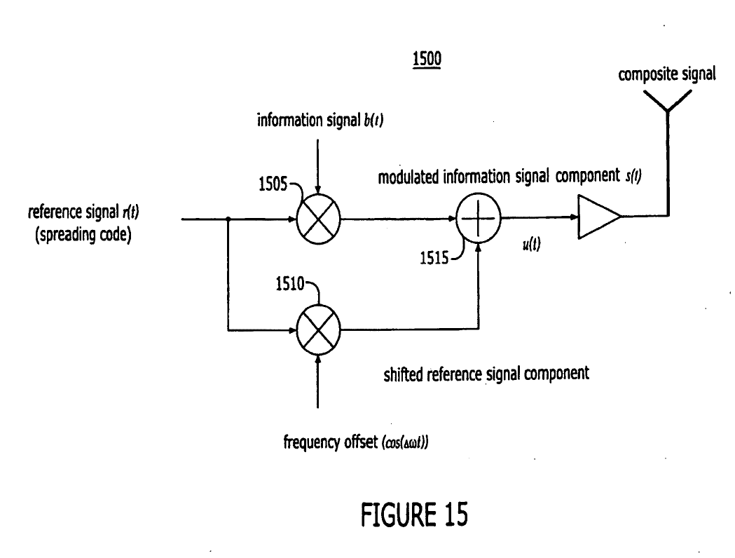

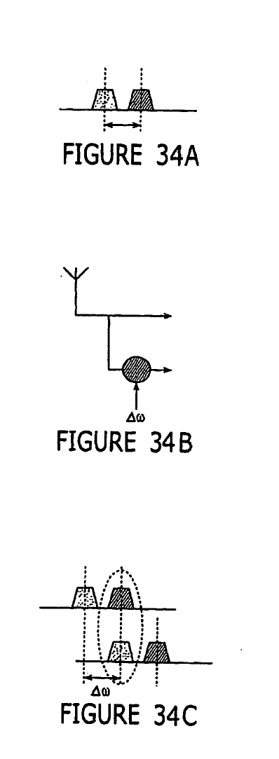

FIG. 15 is a schematic diagram that illustrates embodiments of transmitter circuits 1500 included in electronic devices according to the invention. As shown in FIG. 15, a reference signal (or spreading code) r(t) is provided to a multiplier (or modulator circuit) 1505 along with an information signal b(t) (such as data or voice provided by a user), which provides a modulated information signal output. The modulated information signal provided by the multiplier 1505 is a component of a composite signal that is transmitted by the transmitter circuit 1500. The reference signal is also provided to a multiplier 1510 along with a frequency offset Δω, which provides a shifted reference signal (that is shifted by the frequency offset Δω) relative to the reference signal. The reference signal is shifted by Δω relative to the modulated information signal, which is shown in FIG. 34A.

The shifted reference signal output is also a component of the composite signal transmitted by the transmitter circuit 1500. The modulated information signal and the shifted reference signal are provided to an adder circuit 1515 that combines the components (i.e., the shifted reference signal and the modulated information signal) to provide an output that is transmitted as a composite signal by the transmitter circuit 1500.

According to FIG. 15, the shifted reference signal is included in the composite signal transmitted by the transmitter circuit 1500. Therefore, the receiver that applies the same frequency offset can shift the received composite signal to provide a shifted composite signal that can be used to despread/demodulate the received composite signal thereby providing the demodulated information signal at the receiver that was addressed by the transmitter. It will be further understood that the process described above can be applied by any of the transmitters and receivers. For example, another transmitter can also transmit an information signal to the same receiver by using the offset frequency that is determined by the receiver. Furthermore, the transmitter can also transmit to any of the other receivers according to the invention by shifting the respective reference signal by the frequency offset that is determined by the receiver to which the information is to be transmitted.

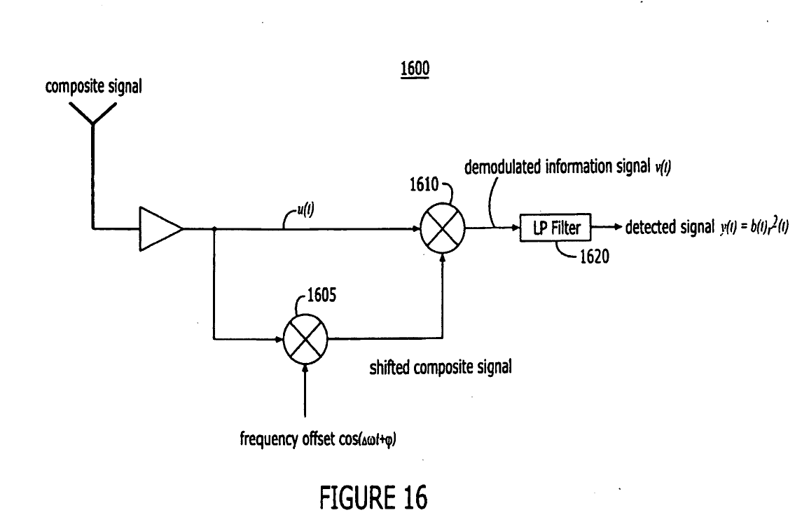

FIG. 16 is a schematic diagram that illustrates embodiments of receiver circuits 1600 in electronic devices according to the invention. In particular, the composite signal that is transmitted by the transmitter circuit 1500 is received and provided to a first multiplier 1605 and a second multiplier 1610. The first multiplier 1605 shifts the composite signal in frequency, such that the shifted reference signal component included in the composite signal aligns in frequency with the modulated information component in the original composite signal. Note that the received signal is multiplied with a local signal cos(Δωt+φ) having a relatively low offset frequency. A receiver circuit may, therefore, avoid use of a relatively high power RF frequency synthesizer circuit.

As discussed above, the shifted composite signal is shifted by at relative to the composite signal u(t) in the receiver circuit shown in FIG. 34B. Accordingly, the component of the composite signal representing the shifted reference signal component of u(t) in the receiver circuit can be aligned to the information signal component included in the shifted composite signal as shown in FIG. 34C.

When aligned, the two components are correlated and the second multiplier 1610 and the low pass filter 1620 produces the information signal that was transmitted by the transmitter circuit 1500. The information signal can be provided by using a low pass filter to provide the detected signal y(t). In other words, the second multiplier 1610 provides a signal having a number of components at different frequencies and at DC. The low pass filter can remove the non-DC components of the signal provided by the second multiplier 1610 and pass the DC component. It will be understood that the DC component, provided by the low pass filter includes the detected version of the information signal that was transmitted to the receiver.

Referring still to FIGS. 15 and 16, the reference signal can have (pseudo-) random noise properties. In particular, the reference signal r(t) can be a pseudo-random sequence of spreading code symbols or chips {−1,1}. Alternatively, r(t) can be purely a noise signal n(t). In some embodiments according to the invention, r(t) is a binary signal, which can have a constant power that can, for example, be derived by hard-limiting a noise signal. The user information signal b(t) can be a bipolar bit stream using the symbols {−1,1}, although other signal formats can be used. Typically, the bandwidth of the information signal b(t) is less than the bandwidth of the reference sequence r(t). In some embodiments according to the invention, the power in the reference signal r(t) averaged over a period corresponding to the information period of b(t) is substantially constant to provide a substantially constant energy for an information bit E_{b}.

As discussed above, the reference sequence r(t) is used as a spreading sequence to spread the user information signal. The information sequence signal after having the reference signal applied to it can be represented as s(t)=b(t)×r(t). The reference signal r(t) is shifted to a higher (or lower) frequency am and is added to the modulated signal s(t) as shown in FIG. 15.

The total transmitted signal u(t) becomes:

u(t)=r(t)cos(Δωt)+s(t) (1)

The frequency offset is relative. In other words, in some embodiments, s(t) can be shifted by Δω and added to r(t) to result in:

u(t)=s(t)cos(Δωt)+r(t) (2)

As shown in FIG. 16, the composite signal (u(i)) is multiplied in the receiver 1600 with cos(Δωt) which shifts the frequency of the composite signal by the same amount as was done with the reference signal component in the transmitter circuit 1500 to provide a shifted composite signal. The shifted composite signal is multiplied in 1610 with the received composite signal to demodulate/depsread the composite signal:

v(t)=u(t)u(t)cos(Δωt) (3)

The above provides four frequency components of the signal v(t):

at DC: b(t)r²(t) (4)

at Δω: b²(t)r²(t)+¾r²(t) (5)

at 2Δω: b(t)r²(t) (6)

at 3Δω: ¼r²(t) (7)

After a low-pass filter, only the term at DC should remain (i.e. b(t)r²(t)). It will be understood that r²(t) is a narrow band signal in comparison to the broadband signal r(t). If r(t) is a binary signal, r²(t) is a constant. If b(t) is also a binary signal, the signal at Δω is a spike in the frequency domain, which can be suppressed using a filter. In some embodiments according to the invention, Δω is larger than the Nyquist bandwidth of the information signal b(t). By increasing the bandwidth of r(t), the spreading ratio can increase, which can provide an Ultra-Large Processing Gain (ULPG) in the receiver circuit 1600. Moreover, since the reference signal is embedded in the received signal, no synchronization of a local reference may be needed in the receiver circuit 1600, which can help avoid long acquisition delays. It will be understood that interfering signals which do not apply the offset used by the receiver circuit (or have no offset at all), are shifted away from the information signal at DC. The interfering signals can, therefore, be filtered out by the low pass filter 1620.

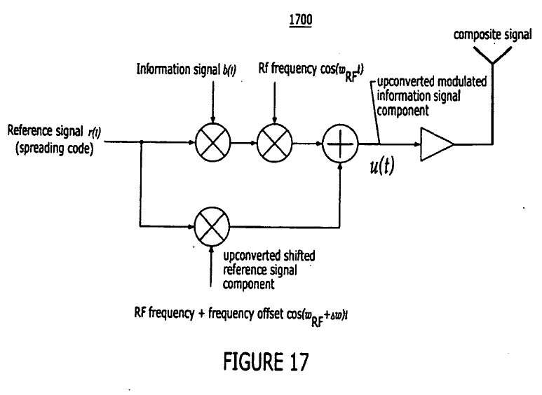

FIG. 17 is a schematic diagram that illustrates transmitter circuits 1700 according to the invention. As shown in FIG. 17, the reference signal is up-converted using a carrier frequency ω_{RF} and is shifted by a frequency offset (as disclosed above in reference to FIG. 15) to provide an up-converted shifted reference signal component. The modulated information signal (i.e., the information signal being spread by the reference signal) is also unconverted using a carrier frequency ω_{RF} to provide an up-converted modulated information signal component. The up-converted modulated information signal component is combined with the up-converted shifted reference signal component to provide the composite signal. In some embodiments according to the invention, the up-converter carrier frequency can be about 2.4 GHz. Other carrier frequencies can be used. It will be understood that, in some embodiments according to the invention, the up-conversion is performed after the combination of the modulated information signal component and the shifted reference signal component.

In the receiver circuit, only the offset Δω need be provided. Accordingly, the sane receiver structure as shown in FIG. 16 can be used to receive signals transmitted by the transmitter circuit 1700. The frequency components provided can be represented as:

at DC: b(t)r²(t) (8)

at Δω: ½b²(t)r²(t)+¼r²(t) (9)

at 2Δω: b(t)r²(t) (10)

In the described embodiments, some components may be present at about 2ω_{RF}, which may be ignored as those components may be suppressed by a low-pass filter in the receiver. As will be appreciated by those skilled in the art, as shown by equations (8) to (10), the value of ω_{RF} may not be critical for operation of the receiver. In some embodiments according to the invention, the transmitted signal can be changing to any frequency by changing tar over a range of discrete hop carriers or by sweeping up and down continuously. The receiver circuit 1600 may not need to synchronize to the hopping and sweeping of the transmitter as long as the components in the transmit signal remain at a fixed frequency offset of Δω. In some embodiments according to the invention, the carrier frequency ω_{RF} used to up-convert the modulated information signal and the shifted reference signal can change over time according to a hopping sequence that is known by the receiver.

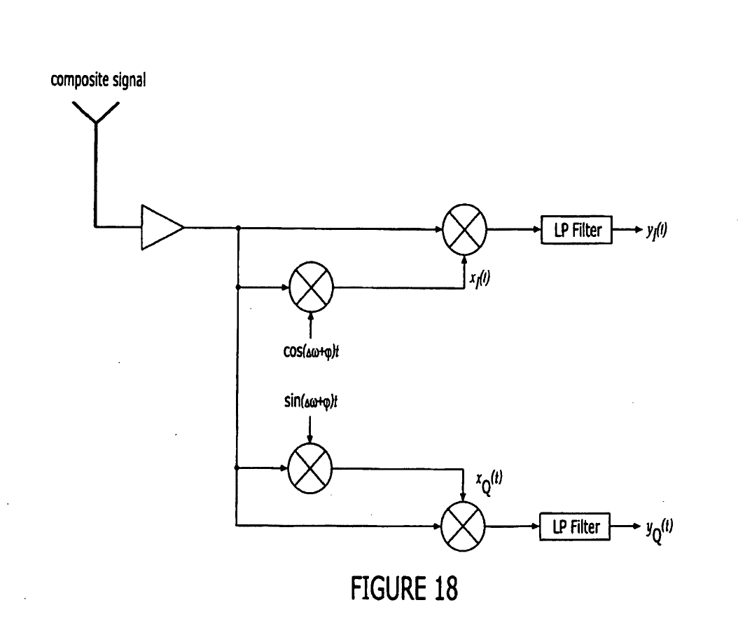

In some embodiments according to the invention, an unknown phase difference φ can exist between an oscillator in the transmitter and in the receiver. The phase difference φ can be manifested as a cos(φ) coefficient of the information signal. The phase difference φ may be addressed by applying a complex receiver as shown in FIG. 18, where I and Q components are generated by applying quadrature mixing.

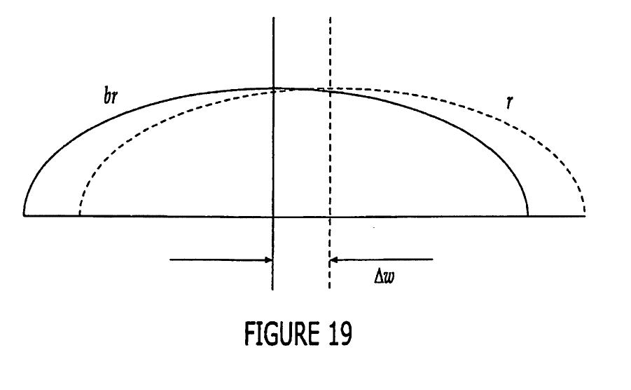

In some embodiments according to the invention, the frequency offset is much less than the bandwidth of the reference (or spreading) signal. Accordingly, the components of the modulated information signal and the shifted reference signal may overlap as shown, for example, in FIG. 19.

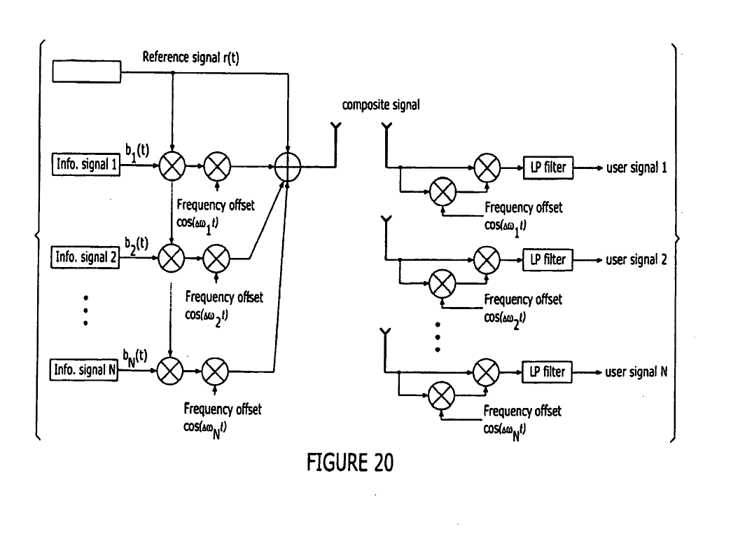

FIG. 20 is a schematic diagram that illustrates embodiments of the transmitter and receiver circuits according to the invention. In particular, all of the transmitter circuits in FIG. 20 use the same reference signal r(t) to spread the respective information signals generated by the different transmitters. Furthermore, the transmitters apply different frequency offsets to transmit to the different receivers. The outputs of the different transmitters shown in FIG. 20 can further be combined to provide a combined composite signal that is transmitted over the single antenna. It will be understood that the transmitters shown in FIG. 20 can be included in a single device.

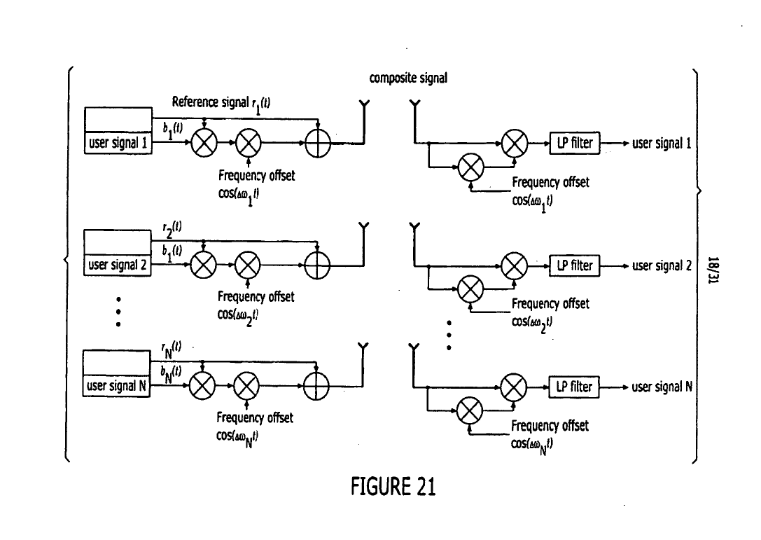

The receiver circuits use respective multiplier circuits to shift the composite signal by the respective frequency offset for that receiver. As discussed above, the shifted composite signal is multiplied with the received composite signal to despread/demodulate the signal. The output of the multiplier is processed by a low pass filter to remove all but the DC components to provide the received information signal for the respective receiver. Alternatively, the transmitter circuits may each provide a separate reference signal rₙ(t) as shown in FIG. 21.

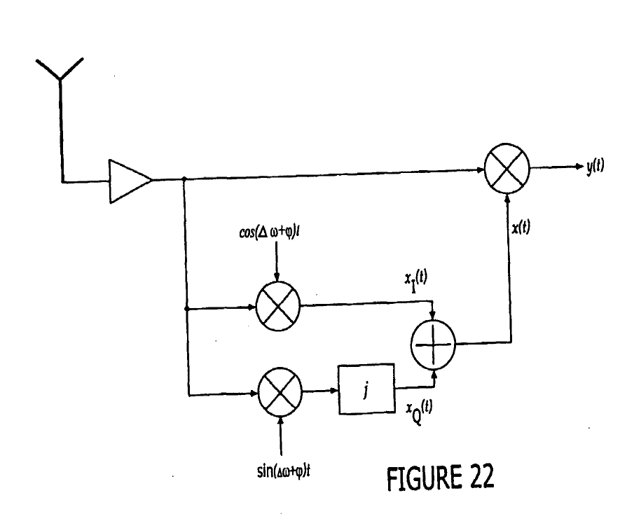

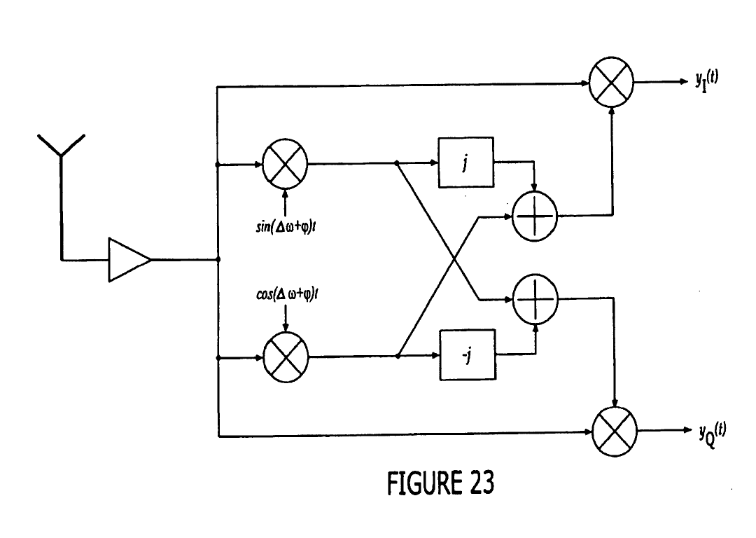

The mixing of the received signals shown in FIGS. 20 and 21 can generate significant harmonics in the output. In some embodiments according to the invention, some of the harmonics can be suppressed more easily by using binary valued reference sequences since squaring these signals produces narrowband carriers (i.e., spikes in the frequency domain). These harmonics can then easily be suppressed by a broadband filter having nulls at the proper places. In some embodiments according to the invention, the harmonics can be suppressed by using an image rejection receiver, such as quadrature mixers as shown in FIGS. 22 and 23. In particular, in FIG. 22, a conventional image rejection mixer can be used when shifting the received signal. As shown in FIG. 23, a complex receiver with image rejection can be used to resolve any phase uncertainty.

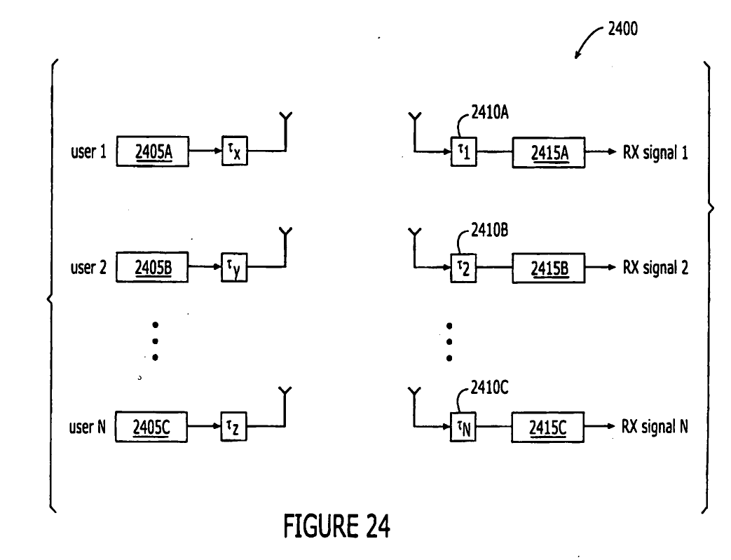

In further embodiments according to the invention, a unique channel can be provided in ad-hoc and multiple access systems using a time offset as shown in FIG. 24. According to FIG. 24, each receiver defines a time offset τ that the transmitters can apply during transmission to transmit data to any of the receivers. It will be understood that the delay can be provided to the reference signal component or to the information signal. In particular, each of the transmitters 2405A-2405C uses a respective time offset τ to transmit to different receivers 2415A-C in a multiple access system 2400. For example, a receiver 2415A determines a first time offset τ₁ over which any of the transmitters 2405A-C can transmit data thereto. The first transmitter 2405A uses the unique time offset τ₁ to transit data to the first receiver 2415A. Similarly, the second receiver 2415B determines a second unique time offset τ₂, which transmitters 2405A-C can use to transmit data thereto, whereas the third receiver 2415C determines another unique time offset τ_{N} which transmitters 2405A-C can use to transmit data thereto. It will be understood that the terms τ and Δτ are used interchangeably herein to refer to the same time offset, such as in the drawings and in the descriptions thereof.

By using a unique time offset r, each receiver only demodulates data that is transmitted using the corresponding time offset. For example, the receiver 2415A uses the time offset τ₁ to receive, accordingly, the first transmitter 2405A needs to use τ₁ as the value of the time offset τₓ to transmit to the first receiver 2415A. Similarly, the second transmitter 1405B uses τ₁ as the value of the time offset τ_{y} to transmit to the first receiver 2415A. Finally, the third transmitter 2405C uses τ₁ as the value of the time offset τ₂ to transmit to the first receiver 2415A. Furthermore, the transmitters 2405A-C use the time offsets determined by the second and third receivers 2415B-C to transmit to those receivers in a similar fashion. Accordingly, the different time offsets determined by the receivers allow the transmitters to communicate with any of the receivers in the multiple access system 2400 simultaneously.

In further embodiments according to the invention, the time offsets can be utilized in transmitter and receiver circuits that transmit and receive a composite signal that includes both an information signal as well as a reference signal. The time offset is used to delay either the modulated information signal or the reference signal prior to transmission.

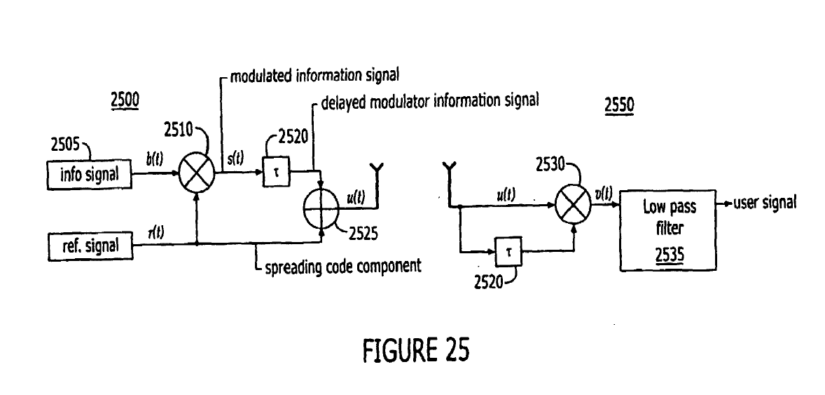

FIG. 25 is a schematic diagram that illustrates embodiments of transmitter and receiver circuits according to the invention. In particular, an information signal b(t) 2505 is provided to a multiplier 2510 in a transmitter circuit 2500. A reference signal r(t) is also provided to the multiplier 2510 which outputs a modulated information signal that is delayed using a time offset 2520 to provide a delayed modulated information signal. The reference signal r(t) is added to the delayed modulated information signal by an adder 2525 to provide a composite signal for transmission. It will be understood that the transmitted composite signal includes the reference signal component r(t) and a delayed modulated information component.

According to FIG. 25, the modulated information signal s(t) is delayed by a delay 2520 and is then added to the reference r(t). The composite transmitted signal u(t) is represented by:

u(t)=r(t)+s(t−τ)=r(t)+b(t−τ)r(t−τ). (11)

At a receiver circuit 2550, the composite signal u(t) is multiplied (using a multiplier 2530) with a delayed version of the composite signal u(t) that is provided using a delay that is determined by the respective receiver (and is, therefore, applied by the transmitter so as to transmit to the particular receiver):

v(t)=u(t)u(t−τ)=r(t)r(t−τ)+b(t−τ)r(t−τ)r(t−τ)+r(t)b(t−2τ)r(t−2τ)+b(t−τ)b(t−2τ)r(t−τ)r(t−2τ). (12)

A low-pass filter 2535, which is used to filter the output v(t), provides the output b(t−τ)r(t−τ)r(t−τ)=b(t−τ) since it is the only term which is despread. It will be understood that the same result can be obtained if, instead of delaying s(o) and adding it to r(t), r(t) were delayed and added to s(t) to provide u(t)=b(t)r(t)+r(t−τ). By proper choice of the autocorrelation of r(t) and of the delay 2520, the interference of the other terms may be suppressed. For example, r(t) can be a very large spreading sequence which can provide Ultra-Large Processing Gains in the receiver. Moreover, since the reference is embedded in the received signal, no synchronization of a local reference may be needed and long acquisition delays may be avoided.

It will be understood that in some embodiments according to the invention, an up-conversion to RF can be performed on the modulated information signal and the spreading code components shown, for example in FIG. 25, separately (before the combination to provide the composite signal) or after the components have been combined in an analogous fashion to that described above in reference to FIG. 17.

ULPG systems can have large transmission bandwidth. For example, if the information bandwidth is 1 MHz and a processing gain of 30 dB is desired, the transmission bandwidth will be 1 GHz (i.e., Ultra-Wideband (UWB) transmission). The signal power can be spread out over a very large spectral area, thus providing very low spectral density (in W/Hz).

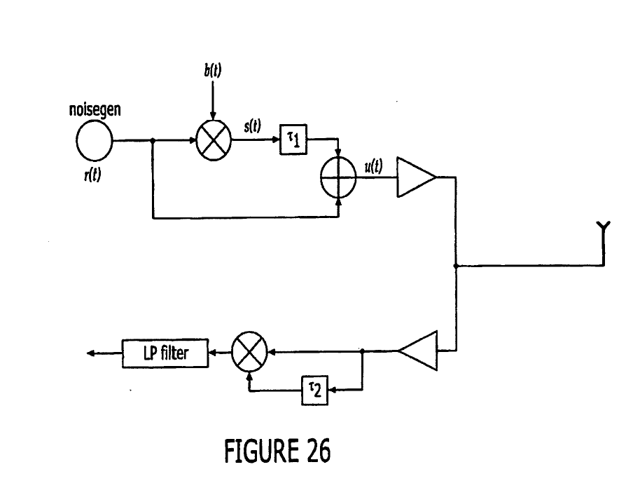

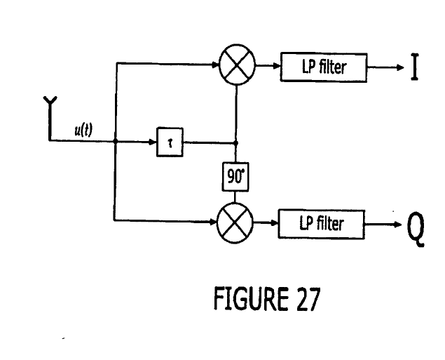

FIG. 26 is a schematic diagram that illustrates embodiments of transceiver circuits applying ULPG and noisy sources. Prior to transmission u(t) can be multiplied with any signal q(t) given that q(t)q(t−τ)=1. For example, the transmitted signal can be up-converted to a dedicated RF frequency q, which can be changing over tine according to a frequency hop schedule. It will be understood that the use of a local oscillator or synthesizer in the receiver portion of FIG. 26 may be avoided. The use of a sharp bandpass filter may also be avoided. Accordingly, the demodulation may occur directly in the radio frequency domain (i.e., there may be no need for down-conversion step). It will be understood that the same receiver shown in FIG. 25 can be used as the receiver portion shown in FIG. 26. In some embodiments according to the invention, the carrier may be hopping from one frequency to another and the receiver may not need to follow the hopping order used by the transmitter to demodulate the signal. If u(t) is multiplied with a carrier q(t)=cos(ωt), there may be some need to coordinate τ and ω such that q(t)q(t−τ)=1. In the implementation of FIG. 26, such coordination can be provided by w=n×2π/τ where n is an integer since then 2 cos(ωt)cos(ω(t−π))=1, where the term at 2ω can be ignored as it is filtered out. In some embodiments according to the invention, a complex receiver is provided as shown in FIG. 27, where no restrictions are placed on ω.

Narrowband, interfering signals will also be shifted and multiplied, which can produce a narrow disturbance at DC. There are several ways of removing this disturbing DC signal from the baseband signal. In one embodiment, Manchester signaling is applied in the user signal b(t). As a result, the baseband signal may not be centered at DC and DC signals can be filtered out. Alternatively, a DC suppression algorithm can be applied as described, for example, in U.S. patent application entitled “Method and Apparatus for Detection of Binary Information in the Presence of Offset, Drift, and other Slowly Varying Disturbances” by J. C. Haartsen and P. W. Dent, filed Jun. 13, 2000, now U.S. Pat. No. 6,563,892 the disclosure of which is incorporated herein by reference in its entirety.

In some embodiments according to the invention, a first receiver can support a second higher-power receiver, wherein the first receiver is used to scan the channel continuously (or frequently) to detect data that is then processed by the second higher-power receiver. If no synthesizer is used in the first receiver, the first receiver can continuously scan the channel defined by τ or by Δω, which can enable the combination of the first and second receivers to operate using relatively little current. For example, in some embodiments according to the invention, the first receiver may be used to “wake up” a higher-powered second receiver that controls operations and establishes the connection after it has been awaken by the first lower power receiver. In other words, the first receiver may provide a low power sleep mode that scans the channel for data and the second receiver may provide a higher performance receiver that operates responsive to the first receiver detecting data to be processed. When the first receiver detects data to be processed, an indication is provided to the second receiver to begin operation. When the second receiver begins operation, the first receiver can cease operations until, for example, the second receiver completes operations. In some embodiments according to the invention, this type of implementation could be used in Radio Frequency Identification (RFID) label applications which can include a high power interrogator and a lower power label.

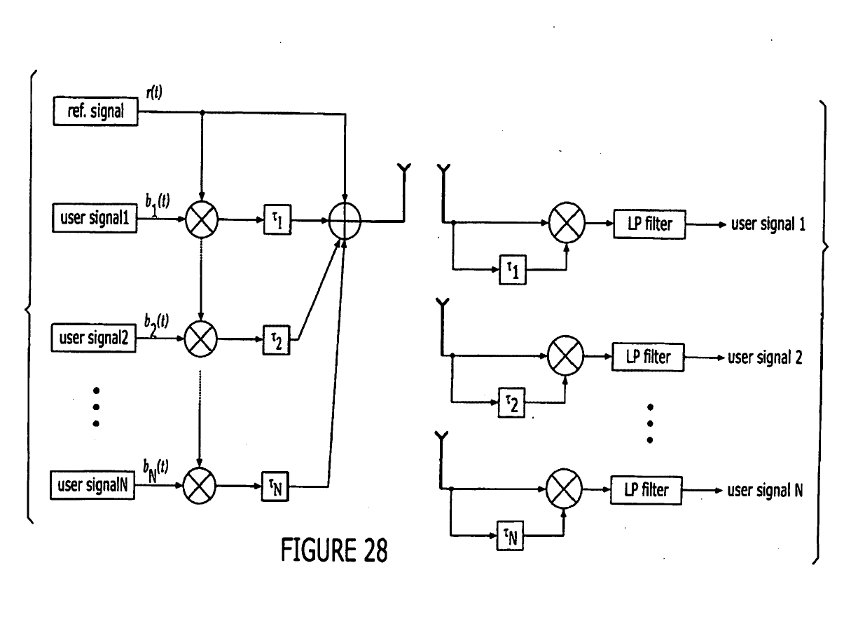

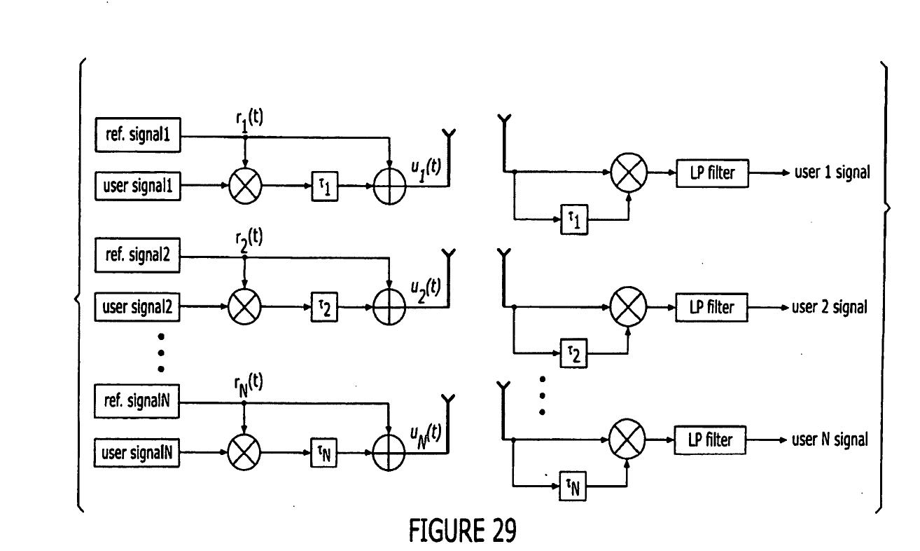

The time offset approaches discussed above can also be applied to multi-user environments, as shown, for example, in FIGS. 28 and 29. The information signal from user 1 is spread using r(t) and delayed by τ₁, the information signal from user 2 is spread using r(t) and delayed by τ2, and so on. In other words, the reference signal is common to all channels. The reference signal r(t) is chosen to have good autocorrelation properties. In FIG. 28, the outputs of the different transmitters are combined to provide a combined composite signal that is transmitted over the single antenna shown. In some embodiments according to the invention, the single device used to transmit the combined composite signal is a base station. The receivers apply the respective delay for the receiver to process the combined composite signal. If any portion of the combined signal was transmitted using a delay for the particular receiver, the receiver will be able to receive that corresponding portion of the combined composite signal.

In FIG. 29, the reference signal r(t) is added to each signal separately. All units can have the same r(t) or, alternatively, each can have their own r₁(t). The power level of the reference signal added can be lower than the power level of the spread information-bearing signal (i.e., a weighting can be applied).

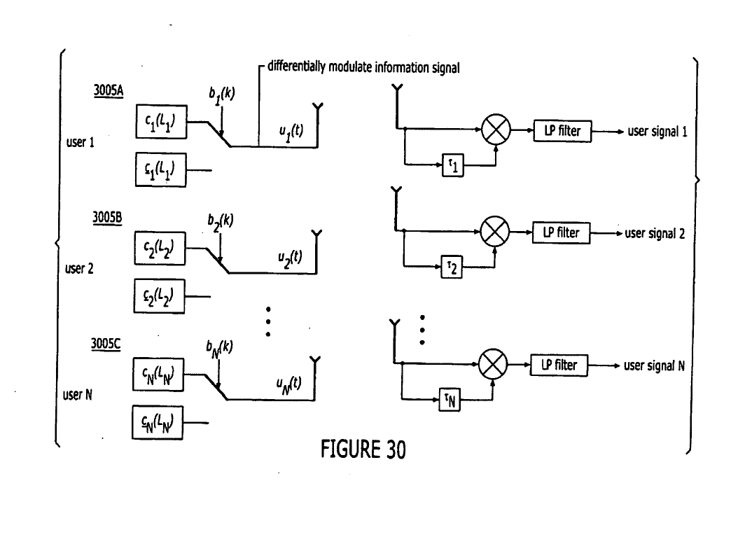

FIG. 30 is a block diagram that illustrates embodiments of transmitters and receivers according to the invention. According to FIG. 30, transmitters 3005A-3005C apply differential modulation to information signals b₁(k) associated with each of the respective transmitters 3005A-3005C. In particular, each transmitter 3005A-3005C includes chip sequence generator circuits that are configured to provide chip sequences for transmission responsive to the data included in the information signals b₁(k). As the data in the information signal changes, the transmitter 3005A-3005C can transmit the corresponding first or second chip sequence. In some embodiments according to the invention, the first and second chip sequences are a chip sequence c and an inverted chip sequence c that is an inverted version of the chip sequence c. In some embodiments according to the invention, the chip sequence c is a broadband chip sequence of length L using the alphabet {−1, 1}. The inverse chip sequence c can be obtained from the original chip sequence by replacing all 1's with −1's and all −1's with 1's.

In some embodiments according to the invention, the differential modulation provided by the transmitters is such that the chip sequence transmitted is changed from a first chip sequence to a second chip sequence if the data included in the information signal b(k) is a logical “1,” whereas the transmitted chip sequence is maintained as the first chip sequence if the data included in the information signal b(k) is a logical “0.” The differential modulation provided by the transmitter therefore can result in a series of chip sequences, having a respective length, being transmitted.

Each of the receivers is configured to receive using a unique chip sequence length. Accordingly, the transmitters can use the different chip sequences having different lengths as different offsets to communicate with different receivers. Accordingly, the different chip sequences and the different lengths thereof can be used by the different transmitters to provide a differentially modulated information signal that is uniquely offset in time depending on which receiver is to receive the transmitted data. For example, when the information signal includes a logical “1” the transmitter can change the transmitted chip sequence from c to c or from c to c (i.e., change the position of the switch in FIG. 30), depending on which chip sequence is currently being transmitted. Alternatively, when the information signal includes a logical “0” the transmitter can continue transmitting the chip sequence as c or as c, depending on which chip sequence is currently being transmitted (i.e., the switch in FIG. 30 remains at its current position). In other words, when the information signal includes a logical “1,” the chip sequence is toggled, whereas the chip sequence is maintained if the information signal includes a logical “0.” For example, a (user) bit series of 1001101001 having differential modulation applied can be transmitted as cccccccccc or as ccccccccccc.

The signal is demodulated by delaying the received signal by the length L of the sequence c and multiplying the delayed version by the current version. By choosing a different L for each receiver, different users can make use of the same medium. The length L is the length of the spreading code expressed in number of chips, and together with the spreading chip rate R_{c}, L maps to a delay τ, which can be expressed as τ=L/R_{c}. The channels differ by having different code lengths Lᵢ, which may be the only parameter known to both the transmitter and the receiver that are in communication. It will be understood that the chip sequence should be chosen to have at least pseudo-random properties.

The receivers for the system described above can be the same as those shown in FIGS. 25, 28 and/or 29. For example, referring to embodiments of receivers illustrated in FIG. 25, the chip sequence of c or c is received by the receiver and delayed by τ (i.e., the length of the chip sequence c). The delayed received chip sequence is multiplied by the received chip sequence which produces a result of a “0” if the delayed received chip sequence is the same as the received chip sequence. Otherwise the result produced is a “1” if the delayed received chip sequence is the opposite of the received chip sequence. There may also be relatively high frequency components if the accuracy of r is not high, which can be filtered out by the LP filter.

Accordingly, the receiver that applies a delay equal to the length L of the transmitted chip sequence can receive the data. If the addressed receiver detects two consecutive chip sequences that are the same (c,c or c,c), a logical “0” is implied as the modulated data, whereas if the addressed receiver detects two consecutive chip sequences that are opposites (c,c or c,c), a logical “1” is implied as being the modulated data.

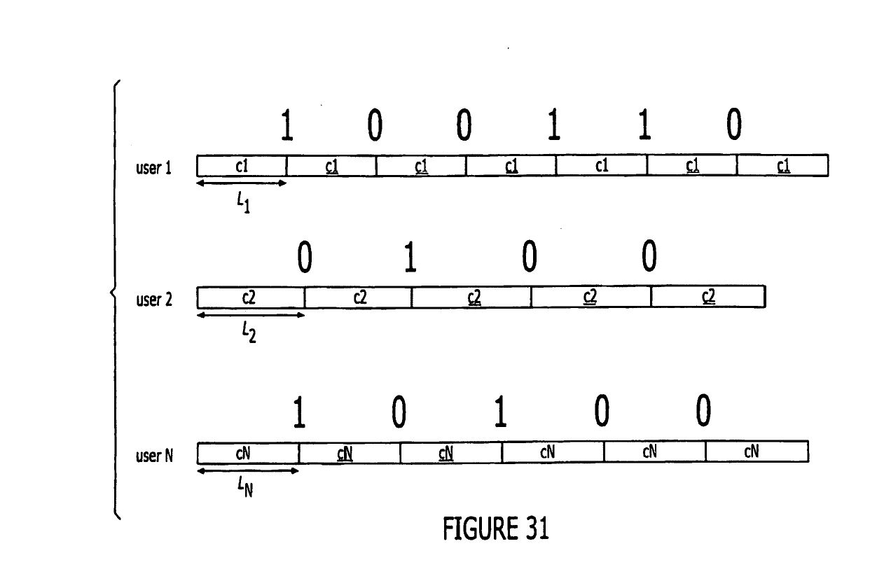

In the system shown in FIG. 30, the transmitted signals may drift in time with respect to each other, due to that the lengths L defined by the different receivers are not equal, as shown in FIG. 31. When codes are chosen randomly, as may be the case in an ad-hoc system where there may be no coordination between transceivers, it is not unlikely that the chosen codes have bad cross-correlation properties. However, since the transmitted signals drift with respect to one another average conditions will prevail, and the system will generally function properly as opposed to a system where the transmitted signals don't drift and consideration must be taken to the worst case alignment of spreading codes. The longer the codes, as in the case of broadband systems, the more statistical averaging will occur.

In other embodiments according to the invention, the sequence c (and c) can be changed to increase randomness. For example, the code may be changed during transmission gaps or for each new packet transmission when the nature of the transmissions is “bursty.”

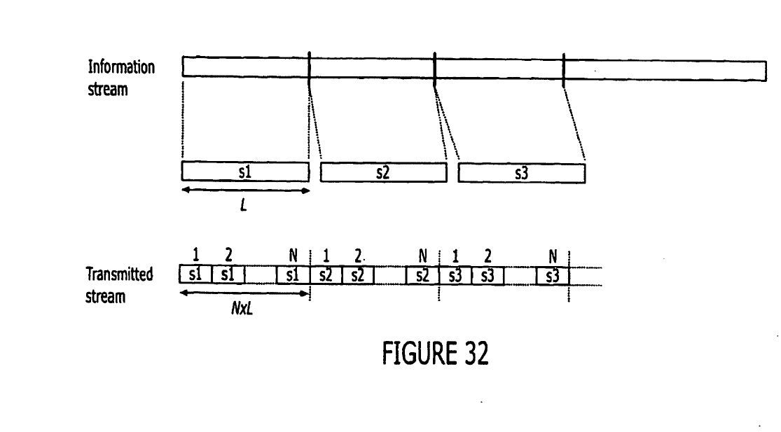

FIG. 32 is a diagram that illustrates transmission of a data strewn according to embodiments of the invention. In particular, the user information is segmented in groups of L information bits. This group is repeatedly transmitted N times at high bit rate R_{b}. So the segments are compressed in time and repetitively transmitted. At the receiver, the repeated groups are accumulated using the delay of L/R_{b} during the window N×L/R_{b}. After this window, the signal is sampled and a new accumulation period starts.

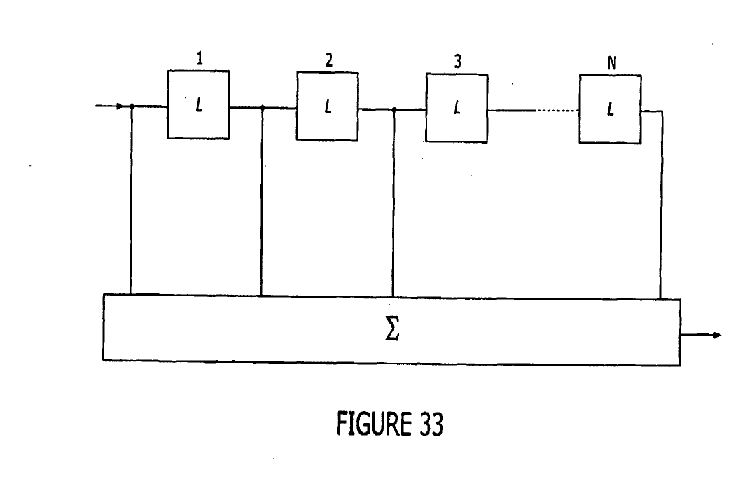

A scrambling code can be applied over the information signal (prior to the segmentation) to provide pseudo-random properties. As shown in FIG. 32, the information signal is segmented in groups s1, s2, etc, each including L bits. These groups are transmitted N times At the receiver, delay sections, each with a delay of L bits are used to retrieve the signal, as shown in FIG. 33. For a multi-user system, each receiver i can have its specific Lᵢ bits per group. By receiving sequences repeatedly and accumulating them, the energy of the signals build up. But instead of building it up by accumulating chips as in DSSS (Direct Sequence Spread Spectrum), here it is done by accumulating the information bit (which is spread in time) itself. The number of repetitions corresponds to the processing gain (like the number of chips in a DS code represents the processing gain of a DSSS system). The transmitter may abort the repeated transmissions when it receives an acknowledgement from the receiver. In this way, only the minimal necessary energy for successful transmission is applied A training sequence or synchronization sequence located at the start of each segment is required for proper decoding of the segment after the accumulation has been finalized.

As discussed above, embodiments according to the invention can provide methods, electronic devices, systems and computer program products for communicating in wireless ad-hoc networks and multiple access systems (such as mobile radio telephone communications systems). For example, in some embodiments according to the invention, a transmitter can transmit data to a first receiver in an ad-hoc wireless network (or multiple access system) over a first channel and can, further, transmit data to a second receiver in the ad-hoc wireless network (or multiple access system) over a second channel that is separate from the first channel, where the first and second channels are determined by the respective receivers which will receive the first and second transmitted data. Accordingly, communications between transmitters and different receivers in the ad-hoc wireless network (or multiple access system) can be carried on simultaneously.

The different channels for the receivers in the ad-hoc wireless network (or multiple access system) can be provided by different offsets. For example, in some embodiments according to the invention, a first receiver in the ad-hoc wireless network (or multiple access system) can specify an identifier that can be used to transmit data to the receiver over a first channel that is specified as a first offset whereas the second receiver specifies a second identifier, which can be used to transmit data thereto over a second channel that is specified as a second offset that is different than the first offset. Therefore, a transmitter can communicate with the first receiver by transmitting using the first offset and can communicate with the second receiver by transmitting using the second offset. Moreover, transmissions to the second receiver are not demodulated by the first receiver as the first and second offsets provide different channels over which communications can be carried out.

In some embodiments according to the invention, the offset is a frequency offset Δω. For example, the first receiver in the ad-hoc wireless network (or multiple access system) can specify a first frequency offset Δω₁ to be used by transmitters wishing to transmit data to the first receiver. A second receiver in the ad-hoc wireless network (or multiple access system) can specify a second frequency offset a over which data can be provided to the second receiver. Accordingly, a transmitter can transmit to the first receiver using the first frequency offset awl and can transmit to the second receiver using the second frequency offset Δω₂.

In still other embodiments according to the invention, the offset is a time offset Δτ. Accordingly, the first receiver can define the first channel as a first time offset Δτ₁ whereas the second receiver can specify the second channel as a second time offset Δτ₂. Therefore, the transmitter can transmit to the first receiver using the first time offset Δτ₁ and can transmit to the second receiver using the second time offset Δτ₂.

In still other embodiments according to the invention, a reference signal (or spreading code) used to spread a transmitted information signal, is transmitted to the receiver as a component of a transmitted composite signal. The receiver can despread the received signal by implicitly using the reference signal that is included in the composite signal. No prior knowledge of the reference signal is needed at the receiver. Embodiments according to the invention can, therefore, use a reference signal that is essentially (or truly) random and is very long as the spreading code. The random nature and the long length of the reference signal can provide very low cross-correlation. The large spreading provided by the reference signals can, therefore, provide what is commonly referred to as “Ultra-Large Processing Gain” for the received signal. Moreover, because the reference signal is transmitted with the data, the receiver may be able to despread the received signal quickly.

Many alterations and modifications may be made by those having ordinary skill in the art, given the benefit of the present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A method of communicating in a wireless ad-hoc network, comprising:
transmitting data to a first receiver included in a wireless ad-hoc network over a first channel determined by the first receiver; and
transmitting data to a second receiver included in the wireless ad-hoc network over a second channel determined by the second receiver.

2. A method according to claim 1, wherein the transmitting comprises transmitting the data to the first receiver and the data to the second receiver from a single transmitter.

3. A method according to claim 1, wherein the transmitting is preceded by requesting identifiers associated with receivers in the wireless ad-hoc network.

4. A method according to claim 3, further comprising:
receiving the identifiers associated with the receivers over a channel that is determined by a transmitter that requested the channel identifiers.

5. A method according to claim 3, wherein requesting comprises transmitting a request for the identifiers over a broadcast channel to which the first and second receivers are configured to listen.

6. A method according to claim 3, further comprising:
receiving a first identifier from the first receiver over a broadcast channel; and
receiving a second identifier from the second receiver over the broadcast channel.

7. A method according to claim 6, further comprising:
using the first identifier to transmit the data to the first receiver; and
using the second identifier to transmit the data to the second receiver.

8. A method according to claim 1, wherein transmitting data to the first receiver further comprises transmitting an identifier associated with a transmitter that transmits the data to the first receiver.

9. A method according to claim 1, wherein the first and second channels are unique in the wireless ad-hoc network.

10. A method according to claim 1, wherein the different channels are unidirectional.

11. A method according to claim 1, wherein the transmitting comprises transmitting the data without identifiers associated with the different receivers.

12. A method according to claim 1, wherein the transmitting comprises transmitting a first spreading code with the data to the first receiver and transmitting a second spreading code with the data to the second receiver.

13. A method according to claim 12, wherein at least one of the first and second spreading codes comprises a noise signal.

14. A method according to claim 12, further comprising:
changing at least one of the first and second spreading codes for subsequent data transmissions.

15. A method according to claim 1, further comprising:
transmitting data over the first channel defined by the first receiver as a first function; and
transmitting data over the second channel defined by the second receiver as a second function.

16. A method according to claim 1, further comprising:
receiving the first data at the first receiver over the first channel; and
receiving the second data at the second receiver over the second channel.

17. A system for communicating in a wireless ad-hoc network, comprising:
means for transmitting data to a first receiver included in a wireless ad-hoc network over a first channel determined by the first receiver, and
means for transmitting data to a second receiver included in the wireless adhoc network over a second channel determined by the second receiver.

18. A computer program product for communicating in a wireless ad-hoc network, comprising:
a computer readable medium having computer readable program code embodied therein, the computer readable program product comprising:
computer readable program code configured to transmit data to a first receiver included in a wireless ad-hoc network over a first channel determined by the first receiver, and computer readable program code configured to transmit data to a second receiver included in the wireless ad-hoc network over a second channel determined by the second receiver.

19. An electronic device for communicating in a wireless ad-hoc network, the electronic device comprising:
a receiver circuit configured to receive data from a first transmitter included in a wireless ad-hoc network over a channel determined by the receiver circuit and configured to receive data from a second transmitter in the wireless ad-hoc network over the channel.

20. An electronic device according to claim 19, wherein the channel is determined by the receiver as a function.

21. An electronic device according to claim 19, wherein the data received from the first transmitter comprises a first composite signal including a first spreading code component and a first modulated information signal component; and
wherein the data received from the second transmitter comprises a second composite signal including a second spreading code component and a second modulated information signal component.

22. An electronic device for communicating in a wireless ad-hoc network, the electronic device comprising:
a transmitter circuit configured to transmit data to a first receiver included in a wireless ad-hoc network over a first channel determined by the first receiver and to transmit data to a second receiver included in the wireless ad-hoc network over a second channel determined by the second receiver.

23. An electronic device according to claim 22, further configured to request identifiers associated with the first and second receivers in the wireless ad-hoc network.

24. An electronic device according to claim 22, wherein the transmitter circuit is configured to transmit a first spreading code with the data to the first receiver and to transmit a second spreading code with the data to the second receiver.

25. A method according to claim 24, wherein at least one of the first and second spreading codes comprises a noise signal.

26. An electronic device according to claim 22, further configured to transmit data over the first channel defined by the first receiver as a first function and configured to transmit data over the second channel defined by the second receiver as a second function.

27. A method for communicating in a wireless network, comprising:
receiving at a first receiver circuit a composite signal including a modulated information signal component corresponding to a first portion of a data transmission and a spreading code component used to modulate the information signal to provide an indication that the data transmission is addressed to an electronic device including the first receiver circuit; and
beginning operations of a second receiver circuit coupled to the first receiver circuit responsive to the indication that the data transmission is addressed to the electronic device.

28. A method for communicating in a wireless network, comprising:
receiving a composite signal including a first modulated information signal component and a first spreading code component used to modulate the information signal that corresponds to a first portion of a data transmission; and
receiving a second modulated information signal component corresponding to a second portion of the data transmission being modulated with a second spreading code that is different than the first spreading code.

29. A method of communicating in a wireless ad-hoc network, comprising:
transmitting data to different receivers included in a wireless ad-hoc network over different channels, wherein the different receivers comprise at least first and second receivers and the different channels comprise at least a first channel over which the first receiver receives the data and a second channel over which the second receiver receives the data and wherein the first channel is determined by the first receiver and the second channel is determined by the second receiver.
